(19) United States
(12) Patent Application Publication
(10) Pub. No.: US 2021/0081858 A1
(43) Pub. Date: Mar. 18, 2021

(54) APPLIANCE FOR RISK ANALYSIS AND MODELING OF COMPLEX SYSTEMS AND PHENOMENA

(71) Applicant: Simone Colombo, Caravaggio (IT)

(72) Inventors: Simone Colombo, Caravaggio (IT); Remo Galvagni, Caravaggio (IT)

(73) Assignee: Simone Colombo, Caravaggio (IT)

(21) Appl. No.: 16/956,266

(22) PCT Filed: Dec. 20, 2018
(86) PCT No.: PCT/IB2018/060448

§ 371 Date: Jun. 19, 2020

(30) Foreign Application Priority Data
Dec. 21, 2017 (IT) 102017000148654

(51) Int. Cl. G06Q 10/06; G06Q 10/10; G06N 7/08

(52) U.S. Cl. CPC G06Q 10/0635; G06Q 10/0637; G06Q 10/105; G06N 7/08; G06Q 10/067; G06Q 10/101; G06Q 10/103

(57) ABSTRACT

The appliance for risk analysis and modeling of complex systems and phenomena comprises: a processing unit operatively connected to a characterization interface, comprising a calculation algorithm and configured to receive an input file at input comprising a plurality of variables/functions of interest and of interdependencies between said variables/functions, necessary to respond to a specific decision-making problem, and to identify by means of this calculation algorithm a risk profile of said complex system/phenomenon; a modeling and control interface f modeling and controlling the risk, configured to identify critical variables and their weight in order to model the risk profile and define a management strategy.

### TECHNICAL FIELD

The present invention relates to an appliance for risk analysis and modeling of complex systems and phenomena.

### BACKGROUND ART

In different and multiple sectors, the need is felt to provide tools which make it possible to assist and guide, in an appropriate way, a decision-maker in the analysis and management of the risk of complex systems and phenomena.

However, the current approaches, mainly dating back to the late 1970s and 1980s, substantially have five major limitations. First and foremost, being the origin of all methodological problems, is the impossibility or practical difficulty of creating a partition, i.e. building the entire universe of possible constituents/scenarios associated with the set of considered/selected variables deemed necessary to respond to the decisional problem to be answered.

The impossibility or practical difficulty of creating a partition (i.e. a complete universe of scenarios) using known methodologies can be put down to two reasons, which do not mutually exclude one another.

The first reason consists in an intrinsic limitation of the logical-methodological construct underlying known methodologies. Take, by way of example, the Fault Tree methodology which, because it provides for the construction of scenarios from the combination of only unsuccessful events and excludes those deriving from combinations of mixed successful and unsuccessful events, permits only a partial representation of reality. Take, again as an example, the Bayesian networks which, because they envisage that each variable (father event) can influence only the next one (son event) and not those beyond the next one (future generations), also permit generating only a part of the universe associated with the considered variables (and, therefore, only partially representing the complexity of the analyzed system/phenomenon).

The second reason consists in a practical limitation tied to the need to create the possible scenarios “manually”. Almost all of the methods of known type fall within what could be defined as a “paper and pen” approach because, despite the support of more or less structured dedicated software, it requires the analyst to derive the scenarios manually using his/her creativity and experience. This characteristic makes them inadequate to analyze and manage the risk of complex systems and phenomena because, even if their logical-methodological construct theoretically were to allow creating a partition, i.e. a complete universe of scenarios, as in the case of the Event Tree methodology, they would require a cognitive capacity far too high for the human mind. In any case, even for the simplest systems/phenomena, where the cognitive limitation is not an impediment to the creation of the partition, the practical impossibility would exist of generating the complete partition/universe in adequate time to support a decision-making process (in this regard, see the application example below). Among the methods of known type, from the point of view of generating the universe of scenarios, the Bayesian networks are an exception (they are not part of the “paper and pen” methods) because they make it possible to automate the creation of the scenarios associated with the considered set of variables. Unfortunately, however, they do not make it possible to create a complete partition/universe because of the limitation related to the logical-methodological construct described in the previous paragraph.

By way of example, a methodology of known type is described in the document US20070011113. Such document describes a method which, through the union of deductive methods (such as the Fault Tree) and inductive methods (such as the Event Tree) aims to obtain the universe of possible scenarios to be analyzed and from which to derive the critical issues.

However, this method, besides having a construct unable to ensure consistency (very definitely as regards the deductive part of the Fault Tree), always assumes a manual approach and, therefore, does not make it possible to automate the creation of a universe of possible scenarios of a complex system/phenomenon.

The impossibility of creating a complete partition/universe, whether due to a limitation of the logical-methodological construct or to the need to manually generate the constituents/scenarios, numerically translates into the impossibility of obtaining a universe of scenarios whose total probability adds up exactly to 1. This numerical limitation has two very important methodological implications, namely:

1. it does not permit calculating the entropy of the partition and, therefore, understanding the amount of information contained in the analysis;
2. it does not make it possible to ensure either the consistency, i.e. the logical-stochastic completeness, or, consequently, the congruence, i.e. the stochastic and phenomenological correspondence between what is foreseen by the prediction model and the empirical evidence associated with the system/phenomenon it is meant to represent.

The verification of congruence between the forecast model and the empirical evidence is, in the risk analysis, a crucial aspect because it permits having a point of anchorage/verification between the forecast and the underlying experience. However, it can only be carried out when the possibility exists of comparing the empirical data with the predictive data deriving from a complete universe which reflects (logically and stochastically) that which produced the empirical data itself (and not only a part of it).

The second limitation, a consequence of the limitation of the logical-methodological construct, is the need for statistical data to conduct the analysis. The Bayesian networks, by way of example, in the absence of adequate training of the network with statistically significant data referring to the system/phenomenon analyzed, do not permit producing a forecast useful for decision-making purposes. This strong limitation makes Bayesian networks unusable for analyzing systems (especially very humanized organizational ones) and/or complex phenomena for which there is not a sufficiently large database to allow an adequate training of the network and, therefore, such as to produce a forecast which could have any usefulness for decision-making. The third limitation, also a consequence of the limitation of the logical-methodological construct, is the inability or practical impossibility to manage the events, understood as a set of constituents/scenarios, in an effective and efficient way. In fact, even if conventional decision support systems are able to ensure a high capacity of storage (database), modeling and visualization for the decision-maker, nevertheless such systems are not able to actively support the management of events. Yet event management is of primary importance because it practically translates into the ability to analyze the system/phenomenon at different levels of abstraction, from different angles and for different purposes, allowing, ultimately, to carry out both logical-stochastic (consistency) and phenomenological (values and patterns of the variables involved) control and that of correspondence with empirical evidence (congruence). In fact, in order to make possible the control of congruence, it is necessary to be able to aggregate, by adding them together stochastically, all the possible constituents/scenarios that could lead to the event being verified (and not only a part of them). Only in this way is it possible to compare the forecast data of the searched event with the empirical one.

The fourth limitation, also a consequence of the limitation of the logic/methodological construct, is the impossibility or practical inability to couple the consequences associated with each single variable, within every possible scenario, to make it possible to calculate the distribution of probability, damage and risk associated with the entire analyzed system/phenomenon. This impediment is very limiting because both the risk profile and the damage profile are needed by the decision-maker to express its own factor of usefulness in defining the risk management strategy. Moreover, the impossibility of obtaining damage and risk distribution does not allow the analyst and the decision-maker to verify whether the solutions selected in order to reduce the overall risk would actually do so or, on the contrary, would increase it and where (a more frequent situation than one might think).

The fifth limitation—a consequence of the impossibility of coupling the consequences associated with each individual variable within each possible scenario—is the inability to identify the critical variables as a function of their contribution to the risk identified on the basis of the overall risk associated with the entire analyzed system/phenomenon. In this respect, the methods of known type identify the critical variables according to the logical-stochastic part only, leaving aside the phenomenological analysis of consequences and thereby reducing the risk analysis to a mere stochastic analysis. The consequences are in fact typically calculated a posteriori and only for undesired culminating events (the so-called top events) chosen heuristically (and not according to a consistent logical/methodological construct) and to which they are coupled to calculate the associated risk. In other words, in known types of approaches, the critical variables are identified taking into account only the logical-stochastic contribution which each variable brings with it in leading to an undesired event and excluding the weight, in terms of consequence, associated with that logical-stochastic contribution.

### DESCRIPTION OF THE INVENTION

The main aim of the present invention is to provide an appliance for the risk analysis and modeling of complex systems and phenomena which allows automating the creation of a partition (i.e. a universe complete with possible scenarios) associated with a determinate set of variables deemed necessary to analyze the complex system/phenomenon and respond to the decisional problem.

Another object of the present invention is to provide an appliance for the risk analysis and modeling of complex systems and phenomena which allows actively assisting the analyst and the decision-maker both in generating the damage and risk profile of the analyzed system/phenomenon and in identifying the critical variables in relation to their contribution to the total risk of the system.

Another object of the present invention is to provide an appliance for the risk analysis and modeling of complex systems and phenomena which allows actively assisting the decision-maker in the modeling and control of the risk in order to make it possible to both verify the soundness of the solutions identified to reduce the risk and to express its own factor of usefulness.

The aforementioned objects are achieved by the present appliance for the risk analysis and modeling of complex systems and phenomena having the characteristics of claim 1.

### BRIEF DESCRIPTION OF THE DRAWINGS

Other characteristics and advantages of the present invention will become more evident from the description of a preferred, but not exclusive embodiment of an appliance for the risk analysis and modeling of complex systems and phenomena, illustrated by way of an indicative, but non-limiting example, in the attached drawings in which:

FIG. 1 is a general diagram of the appliance according to the invention;

FIG. 2 schematically shows the general structure of the working software platform of the appliance according to the invention;

FIGS. 3, 4, 5 and 6 schematically illustrate the functions of the characterization interface of the appliance according to the invention;

FIGS. 7 and 8 schematically illustrate the phenomenological modeling functions of the appliance according to the invention;

FIGS. 11 to 24 schematically illustrate the risk analysis and modeling functions of the appliance according to the invention; Figures from 25 to 28 schematically illustrate an example of application of the appliance according to the invention.

### EMBODIMENTS OF THE INVENTION

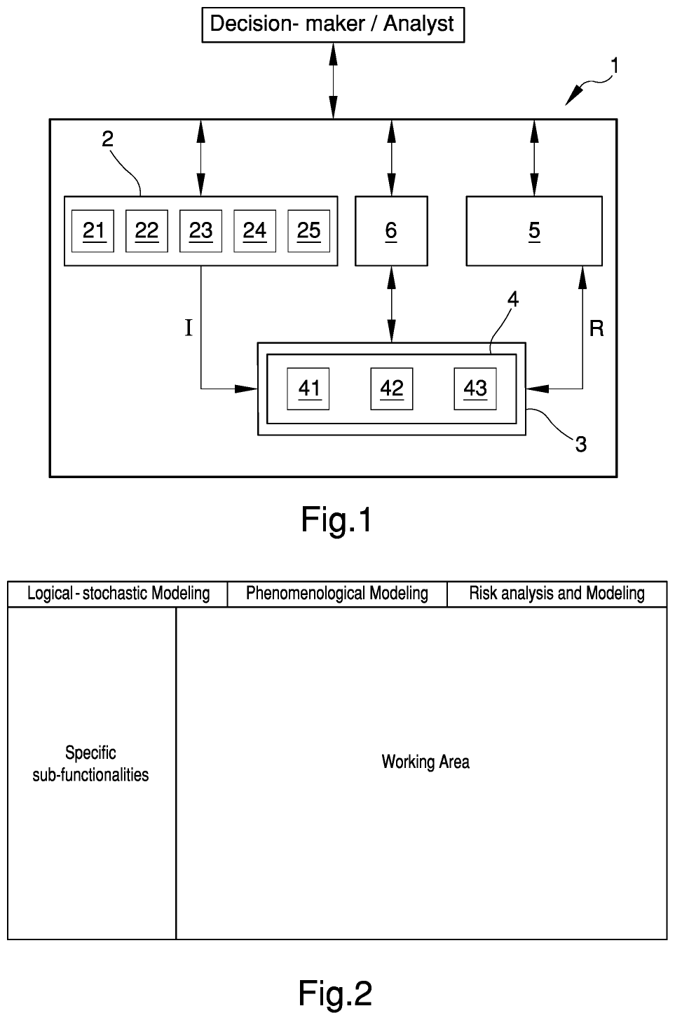

With particular reference to FIG. 1, reference numeral 1 globally indicates an appliance for the risk analysis and modeling of complex systems and phenomena.

In particular, the appliance 1 comprises:
a characterization interface 2 of a complex system/phenomenon to be analyzed, configured to generate an input file I comprising a comprising a plurality of variables and functions of interest and of interdependencies between said variables and functions, necessary to respond to a specific decision-making problem;
a processing unit 3 operatively connected to the characterization interface 2, comprising a calculation algorithm 4 and configured to receive an input file I at input and to identify by means of the calculation algorithm 4 a risk profile R of the complex system/phenomenon;
a risk modeling and control interface 5, configured to identify critical variables and their weight in order to model the risk profile R and define a management strategy.

The appliance 1 according to the invention can be implemented through a software platform (system) operating both locally, i.e., on a single personal computer not connected to the Internet, and in cloud computing.

Conceptually, the software platform is divided into three macro areas: a first area for the definition of the logical-stochastic part, a second area for the definition of the phenomenological part and a third area for the risk analysis and modeling.

FIG. 2 schematically shows the general structure of the working software platform of the appliance 1.

The first area for the definition of the logical-stochastic part includes all the functions of the characterization interface 2 used for the characterization of the input file I to be used for the creation of the universe/partition of possible scenarios.

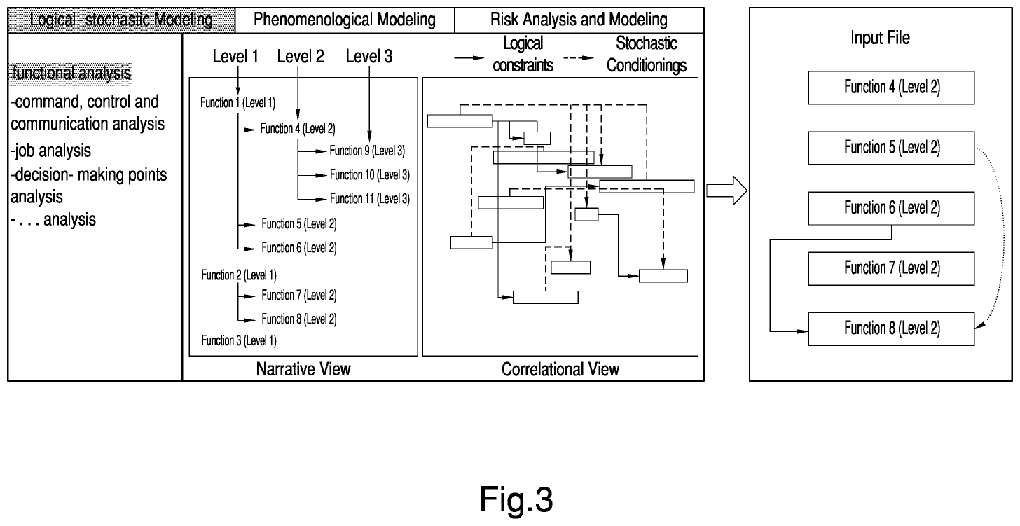

FIGS. 3, 4, 5 and 6 show a schematic example of the structure of the characterization interface 2.

Falling within the second area for the definition of the phenomenological part are the software programming and mathematical modeling languages making up the calculation algorithm 4 implemented on the processing unit 3 of the appliance 1, functional to the construction of the phenomenological model to be used for the definition of the consequences.

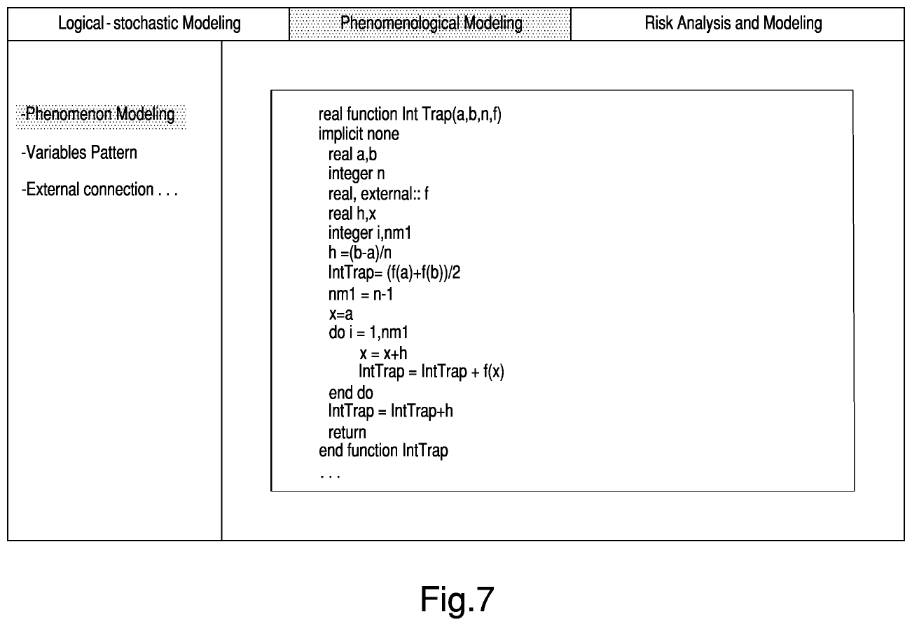

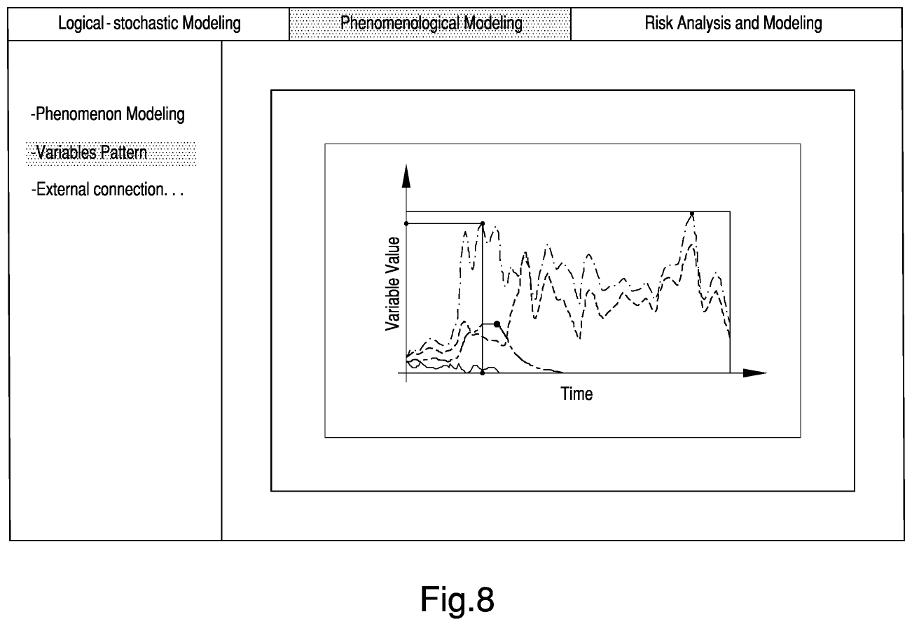

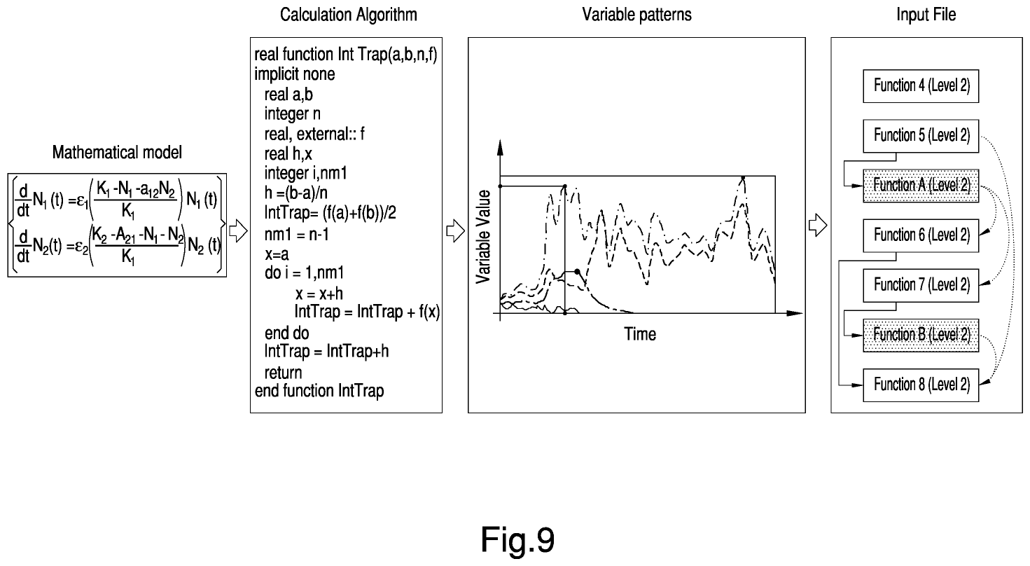

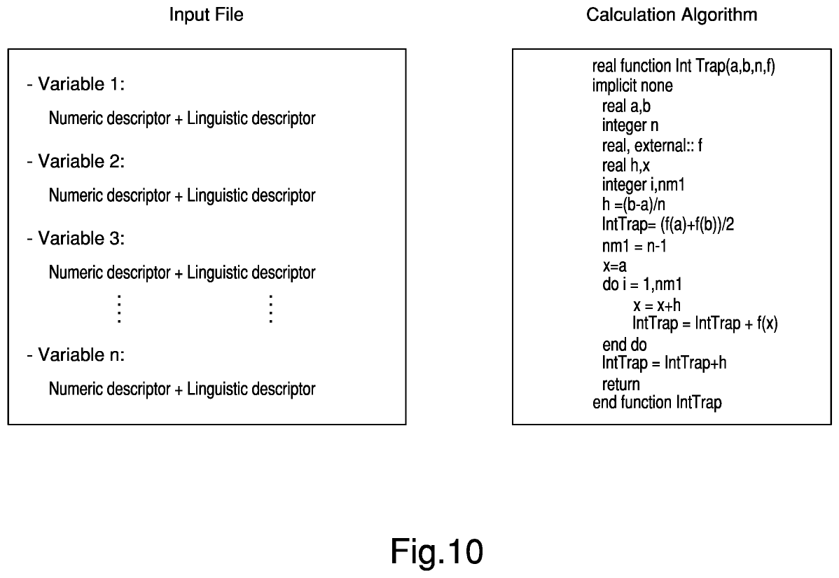

FIGS. 7 and 8 show an example of a structure for the phenomenological modeling part.

Finally, falling within the third part of risk analysis and modeling are all the functions of the risk modeling and control interface 5 used to calculate and represent the risk profile R and, finally, to model and control the risk.

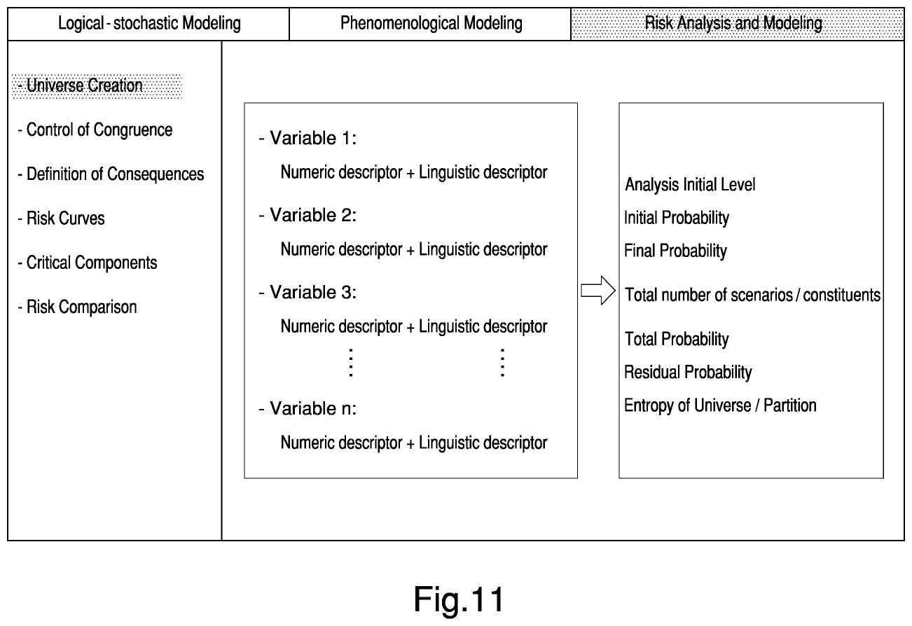

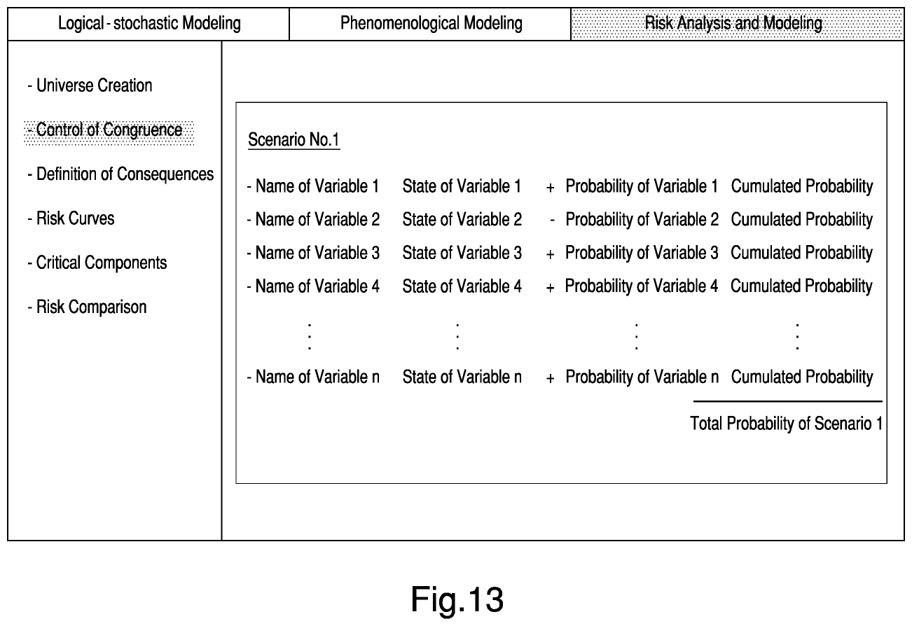

FIGS. 11, 12, 13, 14, 17, 18, 19, 20 and 21 show an example of a structure for the part of risk analysis and modeling.

The characterization interface 2 is used to allow the understanding of the complex system/phenomenon to be analyzed.

The characterization interface 2 is specifically used to generate an input file I to be used to produce, through the calculation algorithm 4 implemented on the processing unit 3, the partition/universe of the possible scenarios and the risk profile of the complex system/phenomenon to be analyzed.

More specifically, the characterization interface 2 allows representing and describing the system/phenomenon to be analyzed at functional level, with regard to all its component parts, i.e.:
the technological component (plant-processing and algorithmic, i.e., hardware and software);
the human component (human activities, i.e., cognitive and physical);
the organizational component (roles and organizational processes).

In particular, the characterization interface 2 comprises:
an interface 21 for functional analysis;
an interface 22 for command, control and communication analysis;
an interface 23 for job analysis;
an interface 24 for decision-making points analysis;
an interface 25 for phenomenological analysis.

Preferably, the functional analysis is, in order of time, the first, among the schematizations, that should be carried out. However, the carrying-out order does not prejudice its methodological usefulness.

Specifically, the interface 21 for functional analysis is configured to simultaneously represent:
a list of variables and functions that make up the complex system/phenomenon to be analyzed;
sequentiality, length of time and mutual interdependencies (logical and stochastic constraints) between the variables and functions.

In particular, the interface 21 for functional analysis is configured to select, out of said represented variables and functions, only the variables and functions which describe a decision-making problem to which one wants to reply.

FIG. 3 shows an example of how the interface 21 for functional analysis could be represented.

Advantageously, the interface 21 for functional analysis is configured to represent such list of variables and functions in a mode called “narrative view”, i.e. a view able to reflect and describe the level of decomposition of the system/phenomenon, the so-called indentation or depth, consistently with its logical-phenomenological behavior. Moreover, the representation of sequentiality, length of time and mutual interdependencies between variables and functions is briefly called “correlational view”.

In practice, the two views have the following methodological purposes.

The “narrative view” has as its double objective that of allowing the analyst to:
select, among all the identified and represented variables making up the system/phenomenon, only the variables/functions strictly necessary to describe the decisional problem which has to be answered;
ensure a homogeneous granularity, i.e. the same level of indentation/depth, in the selection of the variables; a crucial and critical aspect for ensuring a balanced risk analysis which reflects the system/phenomenon being analyzed.

The “correlational view” has as its double objective to:
induce the analyst to identify, by representing them, the logical and stochastic interdependencies between the variables/functions;
allow the analyst to clearly and quickly distinguish between logical constraints and stochastic conditionings between the different variables/functions of the complex system/phenomena to be analyzed also according to the level/depth of analysis; crucial and critical aspect for ensuring a risk analysis free from logical inconsistencies.

According to a possible embodiment, the interface 21 for functional analysis can be implemented by appropriately adapting the basic principles of the well-known GANTT diagram.

Advantageously, the interface 21 for functional analysis is configured to generate the input file I and to store the variables and functions selected together with the respective dependencies inside the input file I.

Consequently, the result of the functional analysis is concretized in a first list of possible variables of interest/pertinence (at the same descriptive level) with the relative interdependencies (i.e. the logical constraints and the stochastic conditionings) to be used for the creation of the input file (see the example of FIG. 3).

Advantageously, the input file I comprises data represented in a numeric-linguistic type form.

In particular, such numerical-linguistic representation allows producing scenarios in the form of stories easily readable even by people who are not experts in risk analysis. This permits benefiting from the contribution of those who, although not experts in risk analysis, can contribute significantly to the soundness of the results inasmuch as bearers of experience of the specific context.

Consequently, the logical constraints and stochastic conditionings in the input file will be represented with a suitable syntax of descriptive-numeric type and no longer graphically as in functional analysis, while the variables will remain of a descriptive-literal type as in functional analysis.

The interface 22 for command, control and communication analysis is configured to represent inter-functional relations between human functions involved in the complex system/phenomenon to be analyzed, comprising:
a diagram of the command chain, indicating who commands whom/what among the human functions;
a diagram of the control chain, indicating who controls whom/what among the human functions;
a diagram of the communication chain, indicating who communicates with whom/what and in what way among the human functions.

Furthermore, the interface 22 for command, control and communication analysis is configured to identify which types of people and how many people cover every function of the complex system/phenomenon to be analyzed.

Command, control and communication analysis must therefore be coupled to functional analysis in order to understand and model any system/phenomenon involving people.

The schematization of command, control and communication is, in fact, necessary to understand and represent, among the human functions involved, who does/should do what and when, i.e.: who “commands” who/what (i.e., who has decision-making responsibilities), who controls who/what, who should communicate with whom/what and in what way.

Besides this, the schematization of command, control and communication has the further objective of identifying which types of people and how many people cover each function of the system, in order to allow the characterization of the probability values necessary for the subsequent phases of the methodology.

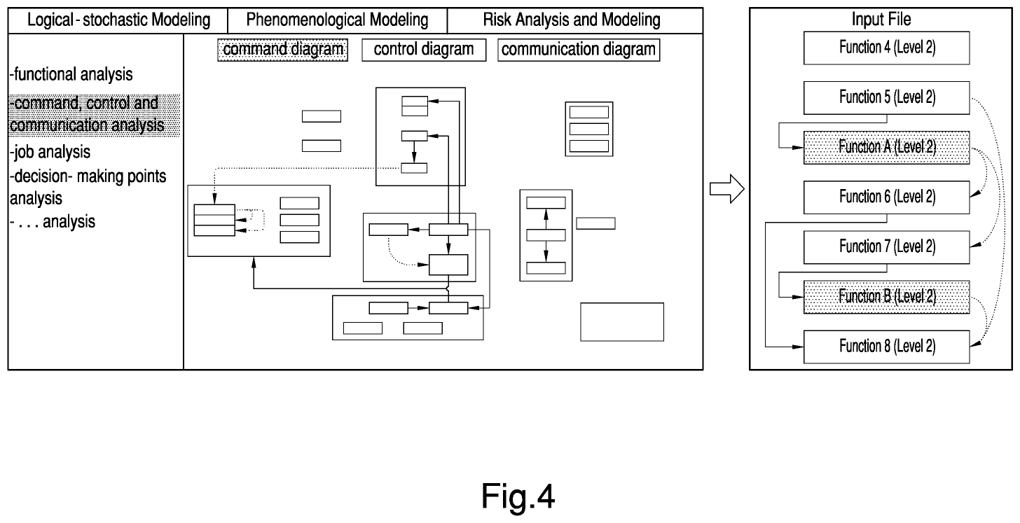

An example of interface 22 for the command, control and communication analysis is shown in FIG. 4.

In the event of the complex system/phenomenon comprises several phases, the interface 22 for command, control and communication analysis is also configured to represent the diagram of the command chain, the diagram of the control chain and the diagram of the communication chain for each of a plurality of phases of the complex system/phenomenon to be analyzed.

This makes it possible both not to confuse the temporal contribution of variables/functions within each of the phases making up the analyzed phenomenon/system and, above all, to reflect the actual multiphase operation/behavior of the analyzed phenomenon/system.

As an example, think of the early warning, alert and emergency phases of an emergency response system.

Each of the different phases may involve different functions and also provide for different functional interrelations (command, control and communication) which have to be clearly and unambiguously represented to allow the proper modeling of the analyzed phenomenon/system and, consequently, the correct prediction of the level of risk and the proper assessment of the effectiveness of the solutions identified to prevent or curb it.

Finally, the interface 22 for command, control and communication analysis is configured to store inside the input file I the inter-functional relations among the human functions.

The result of the schematization of command, control and communication therefore takes concrete shape, within the perimeter defined by the variables of interest/pertinence identified and chosen in the functional analysis, in the identification of the (possible) further variables and to integrate the functional analysis by inserting the human functions, with the relative interdependencies (i.e. the logical constraints and stochastic conditionings), to be included in the input file I to represent the inter-functional relations among the human functions, thus giving an account of who “commands” whom/what, who controls whom/what, who should communicate with whom/what and in what way.

In the hypothetical example of FIG. 4 we can see how the schematization of command, control and communication has made it possible to identify two new functions A and B (always at level 2), two new logical constraints (i.e., that between the function 5 and the function A and that between the function 7 and the function B) and three new stochastic conditionings (i.e., that between the function A and the functions 6 and 7 and that between the function B and the function 8) to be inserted in the input file.

The interface 23 for job analysis is configured to define the activities of people in the complex system/phenomenon to be analyzed.

Therefore, the job analysis is extremely useful when it is necessary to clarify the activities, both manual and cognitive, expected to be necessary by the people in the analyzed context.

In particular, the job analysis aims at inducing the analyst to put him/herself in the shoes of the operators and to look at the system/phenomenon from their perspective.

Therefore, the job analysis helps to better understand whether, at the chosen abstraction level, they can be considered relevant (human) variables, making the analysis more reliable and reflecting the complexity of the system/phenomenon under examination.

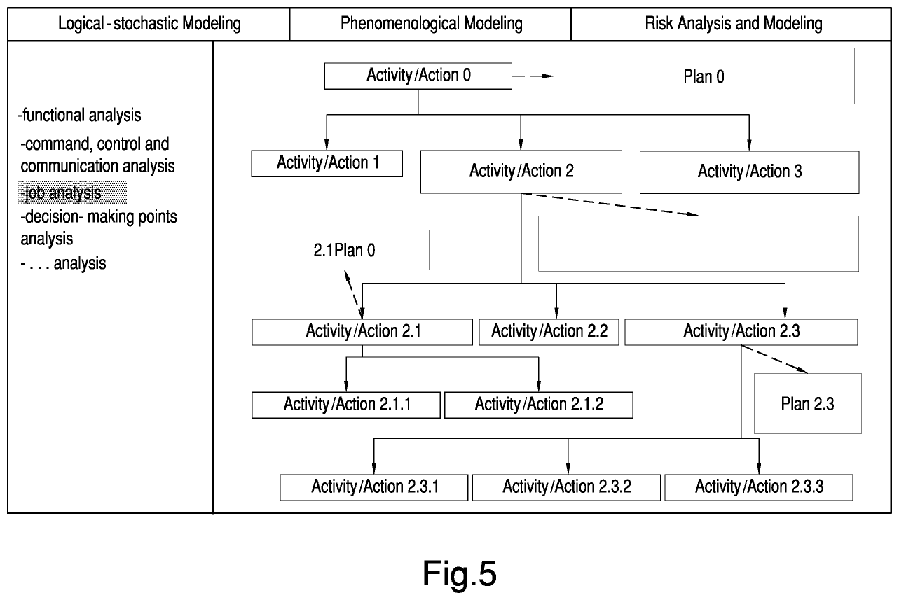

FIG. 5 schematically shows an example of interface for the job analysis of the appliance 1.

The interface 24 for decision-making points analysis is configured to highlight the decision-making points in which each person could review their own decisions.

The interface 24 for decision-making points analysis is particularly useful in diagnosis and control activities as it helps to highlight the decision-making points where the operator could/should review his/her diagnosis/decision and, therefore, potentially err. While functional analysis is guided by the system process or by the evolution of the analyzed phenomenon, the decision-making analysis is guided by the decisions preceding and/or following the performed actions.

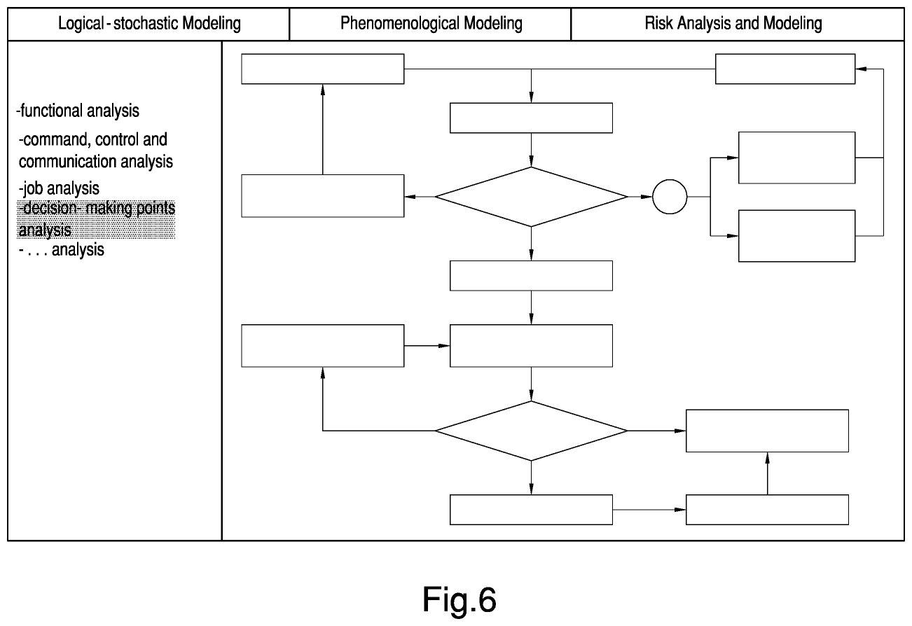

FIG. 6 schematically shows an example of interface 24 for decision-making points analysis.

Job analysis and decision-making point analysis also have as their ultimate objective that of clarifying whether the need exists to include further variables in the input file I (in addition to those identified with the functional analysis and with that of command, control and communication) and/or further interdependencies (i.e. the logical constraints and stochastic conditionings) among those already present in the input file. The interface 25 for phenomenological analysis is configured to generate a mathematical model of calculation of characteristic times of the complex system/phenomenon and of patterns of the variables of interest to be used as reference in the construction of the input file I. FIGS. 7 and 8 show an example of structure for the part of phenomenological modeling.

In particular, the interface 25 for phenomenological analysis comprises a phenomenological simulator for the generation of the mathematical model which, together with the relevant calculation algorithm, is able to calculate the characteristic times of the phenomenon/system and the patterns of the variables of interest to be used as reference in the construction of the input file I, i.e., for the logical-stochastic part. FIG. 9 schematizes the phases of development and use of the phenomenological simulator.

By clarifying the (limit) values of the variables of interest and their (temporal) patterns, the methodological aim of the phenomenological simulator is to both avoid the assumption of limit values, times and, more generally, patterns which are not consistent with the analyzed phenomenon/system, and to permit identifying the central/salient points of the behavior of the phenomenon/system necessary to better characterize the logical-stochastic description in terms of prevalence of variables/phenomena, analysis times, limit values and characteristic times.

Ultimately, therefore, the prime usefulness of the phenomenological simulator is to make the risk analysis more precise and reliable because, in addition to helping to understand the analyzed phenomenon/system, it permits deriving more precise phenomenological (and less heuristic) values.

Besides this, by providing the values of the variables of interest, the phenomenological simulator also permits assessing the magnitude of the consequences. Hence, the second purpose of the phenomenological simulator is to be coupled to the calculation algorithm, consisting of a logical-stochastic simulator, in order to dynamically calculate the risk at system level.

In conclusion, the characterization interface 2 permits generating an input file I and, where practicable, a phenomenological simulation algorithm, both of which to be used with the calculation algorithm 4 implemented on the processing unit 3. FIG. 10 schematically shows the results of the characterization phase.

The input file I contains all (and only) the variables of interest necessary to respond to the decisional problem faced.

Advantageously, as schematically shown in FIG. 10, the input file I is drawn up in a numerical-linguistic form to make possible both the construction of the logical trellis (from which all possible scenarios can be derived) and the description of the scenarios in a narrative form (i.e., in the form of simple stories) understandable even by non-experts in risk analysis (and not in one of the usual cryptic forms, typically graphic, which are difficult to understand).

In particular, each variable stored inside the input file I comprises a linguistic descriptor and a numeric descriptor.

The linguistic descriptor can contain, e.g., the name of the variable and its possible states.

The numerical descriptor is necessary to characterize the variable from the logical and stochastic point of view.

More specifically, the numerical descriptor can contain, e.g., the number of the variable, its probability and its coefficient of variation (necessary to characterize the stochastic part), as well as the number of variables to be connected to according to its possible states and the display mode (necessary to characterize the logical part and describe the stories).

Advantageously, the calculation algorithm 4 implemented inside the processing unit 3 of the appliance 1 comprises a logical-stochastic simulator.

In particular, as schematically shown in FIG. 1, the calculation algorithm 4 comprises:
a generation software procedure 41 for the generation of a complete universe/partition of possible scenarios of the complex system/phenomenon analyzed, starting from the input file I;
an identification software procedure 42 for the identification of any logical inconsistencies and verification of stochastic congruency (made possible through the management of the events);
a calculation software procedure 43 for the calculation of the risk profile R of the complex system/phenomenon analyzed.

Furthermore, the appliance 1 comprises a representation interface 6 for representing the calculated risk profile R.

Therefore, the generation software procedure 41 is configured to process the input file I, created by the characterization interface 2, with a numeric-linguistic syntax and to generate the complete partition/universe of possible scenarios (associated with the variables contained in the input file I and appropriately correlated).

More in general, the software procedure 41 is designed so as to respect the three principles of coherence, shown below.

1. Convexity—expresses the logical need, common to probability and entropy, that the universe of the possible embraces the entire field, placed between the logically impossible and the logically certain, namely: 0≤p≤1.

2. Simple additivity—expresses the logical need for forecasts to have linearity characteristics, and that therefore the forecasts on the universe be made through sums of forecasts, extended to all the alternatives which make it up, namely: p_{Complete Universe}=Σᵢ pᵢ=1 for a complete universe and p_{Universe}=Σᵢ pᵢ for an incomplete universe (subset/event).

3. Product Rule—expresses the logical need that the extension of the universe of the possible be kept consistent with any new information obtained; and that therefore for compound events we have:

A. the degree of expectation of a conditioned event is given by the degree of initial expectation of the compound event, updated to the new universe, made up of the conditioning event, which thus acts as a normalizer, namely:

$$p ( A \vert B ) = \frac{p ( AB )}{P ( B )}$$

B. the measure of the amount of information missing is the initial measure of the compound event, but decreased by the amount of information required to make certain the conditioning event, which has now become certain inasmuch as new universe, namely:

q(A|B)=a(AB)−q(B)

The software procedure 41 for generating the universe/partition is schematically shown in FIG. 11.

Since a universe or a partition can be deemed complete if the sum of the probabilities of all the obtained scenarios (with the variables considered) is exactly equal to 1 (in line with the first principle of coherence), the generation software procedure 41 comprises a function for the calculation of both the total cumulative probability of all the produced scenarios and the residual probability.

Furthermore, the generation software procedure 41 comprises a function for the verification of the following necessary conditions:

p_{Universe}=Σᵢp_{Scenario}_{ᵢ}=1.0000000

p_{Residual}=Σ_{j,j≠from all “i”}p_{Scenario}_{ⱼ}=0.0000000

Since, for the purposes of the risk analysis, the values of interest are those of the probability of failure, therefore typically small values (within the range from 1E−01 to 1E−08 for each single variable considered), the software procedure 41 ensures a precision of calculation of the total probability and of the residual probability to at least the seventh decimal place.

To prove the completeness of the generated universe (i.e. that a partition has been created), the generation software procedure 41 also comprises a function for the calculation of the entropy (of the partition), defined as:

$$S = {\sum }_{i = 1}^{M} [ {p}_{n} \times {log}_{2} ( \frac{1}{{p}_{n}} ) ]$$

where:
pₙ=probability of the n-th constituent/scenario;
M=total number of constituents/scenarios.

The calculation algorithm 4 must also permit analyzing both the entire generated partition/universe (with the variables considered) and a part thereof. This aspect translates into the possibility of choosing a stochastic cut to be applied to the partition/universe to be analyzed below which the algorithm does not analyze the scenarios (or, more precisely, the constituents).

This methodological-algorithmic characteristic is the one which makes the appliance 1 also usable for the analysis of very complex phenomena/systems, which otherwise cannot be analyzed for temporal reasons. Without the stochastic cut, in fact, the calculation times (due to the binary explosion) would not be compatible with the application needs (the analysis of the entire universe/partition could require, given current computational capacities, years or decades of calculations) and would therefore be useless for decision-making purposes.

Advantageously, another characteristic of the calculation algorithm 4 is that of allowing the generation of a reduced partition/universe compared to the one that could be potentially generated if the variables contained in the entire input file were all considered. Therefore, besides the stochastic cut, the calculation algorithm 4 permits considering only one part of the input file I, i.e., only one part of the variables contained in it.

The input file I, built heuristically (albeit with a structured approach) through the characterization interface 2 could contain logical constraints and/or stochastic conditionings not consistent with the complex system/phenomena analyzed.

In this case, the generation software procedure 41 with which the calculation algorithm 4 is provided will generate a partition/a universe which will contain inconsistencies both of a logical type and, consequently, of a stochastic type, i.e. scenarios/constituents (or part thereof) which are logically and, consequently, stochastically incorrect.

The algorithm is therefore provided with a software procedure 42 for identifying possible logical-stochastic inconsistencies, able to highlight them to enable the analyst to correct them through the modification of the input file I.

Therefore, in the case in which the calculation algorithm 4 is unable to assess the correctness of the meaning of the constituent/of the scenario, i.e., is unable to conduct a semantic analysis, it must provide the analyst with all the information necessary to enable him/her to identify them manually.

In particular, for the logical part, the identification software procedure 42 for the identification of inconsistencies is configured to perform a sampling of the scenarios based on the length of each scenario with respect to the average of the scenarios present in the partition/in the universe. This is because the probability that a scenario contains a logical error within itself because of its particular length or brevity, is certainly greater than that containing such error because of its simple position within the partition/universe.

Therefore, the information provided by the software procedure 42 to the analyst could be, by way of example, the average, maximum and minimum length of the scenarios, the number of maximum-length scenarios and those of minimum length, the maximum deviation (with respect to the average value) of the long scenarios and the minimum deviation of the short ones, the list of the maximum-length scenarios and those of minimum length.

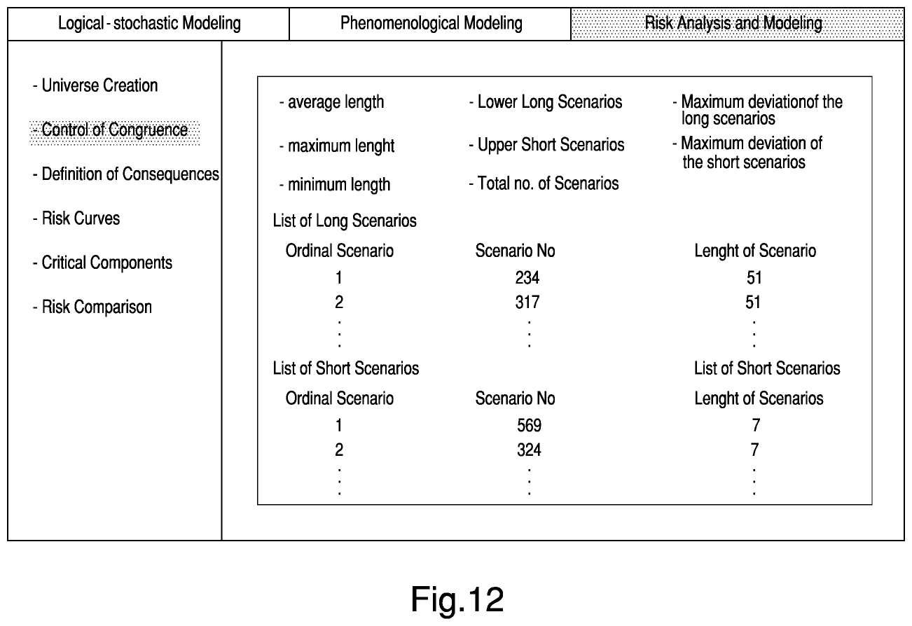

FIG. 12 schematically shows the conceptual structure relating to the control of congruence for the logical part.

In order to enable the analyst to identify the logical inconsistencies, the calculation algorithm 4 must also permit reading the scenarios in the form of stories. FIG. 12 shows an example of a possible representation of the scenarios in the form of stories (which must have the characteristic of being easy to understand even by non-risk analysis specialists).

As far as the identification of stochastic inconsistencies is concerned, the software procedure 42 is configured to allow the analyst to manage the events in accordance with the second principle of coherence, i.e., as the sum of the constituents/scenarios making it up.

Therefore, the software procedure 42 is configured to allow the analyst to select, by extracting them from the partition/universe, and to sum up the constituents/the scenarios making up the searched event, both according to the state (of some) of the variables of the input file I contained inside the constituents/scenarios and, in addition to this, according to additional logics which the event is called upon to satisfy. By way of example only, the software procedure 42 could permit selecting the event consisting of constituents/scenarios which contain inside them the variables selected according to a determined state and a determined sequence. In this specific case, therefore, the software procedure 42 will permit selecting, by extracting them from the partition/universe, and summing up all and only the constituents/the scenarios which contain inside them the selected variables which present themselves according to the searched state and sequence, excluding those which contain the same variables, in the same state but in a different sequence to that searched.

More broadly speaking, the software procedure 42 must permit, from a logical point of view, selecting the variables according to an “AND” logic (logical product) and/or according to an “OR” logic (logical sum).

Conveniently, the selections can be applied both for the congruence control of the logical-stochastic part (the constituents/scenarios) and for the phenomenological part (the consequences).

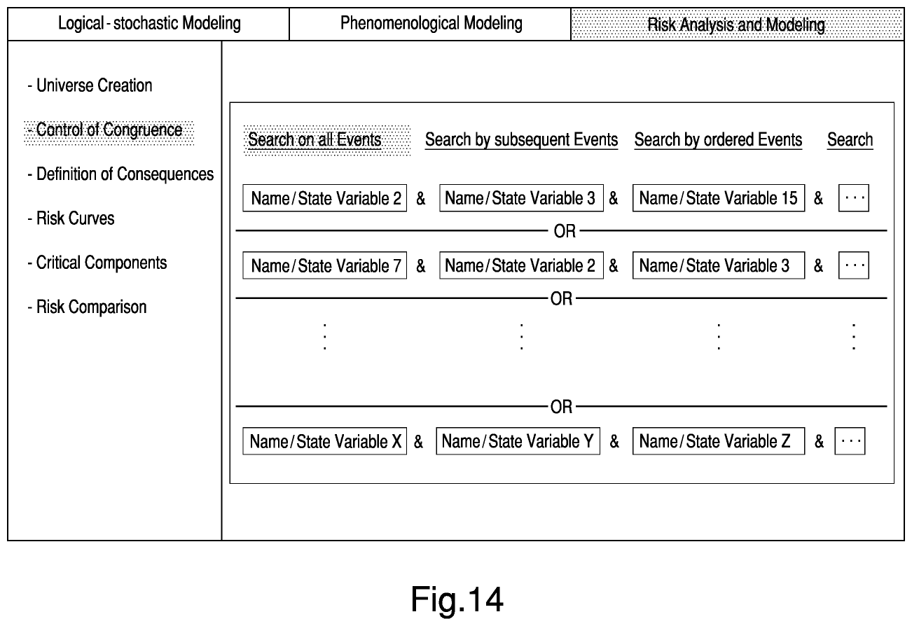

FIG. 14 schematically shows the conceptual structure relating to the selections needed to construct the events whose stochastic congruence is to be controlled (with empirical evidence).

The calculation software procedure 43 for the calculation of the risk profile R implements the classic Risk=Probability×Magnitude correlation.

In particular, the calculation software procedure 43 for the calculation of the risk profile R can be implemented according to three preferred embodiments.

According to a first possible embodiment, the calculation software procedure 43 for the calculation of the risk comprises a function for the assignment, by the analyst and to each variable of the input file, of a value of the consequence (or relative weight with respect to the other variables) according to every possible state of the variable and to any constraints imposed by other variables.

In particular, for each variable, the assigned consequence can comprise both a numerical value and several logical values (representing a state or constraint).

The calculation software procedure 43 for the calculation of the risk profile R uses the numerical value to calculate the risk contribution of the variable within the scenario (as a product of probability by magnitude).

Furthermore, the software procedure 43 uses the logical values as a condition to define the value of the consequence associated with other variables (the value of which would be affected by the state of the considered variable) and to define the conditions (logical constraint) for which the numerical value of the consequence should or should not be counted.

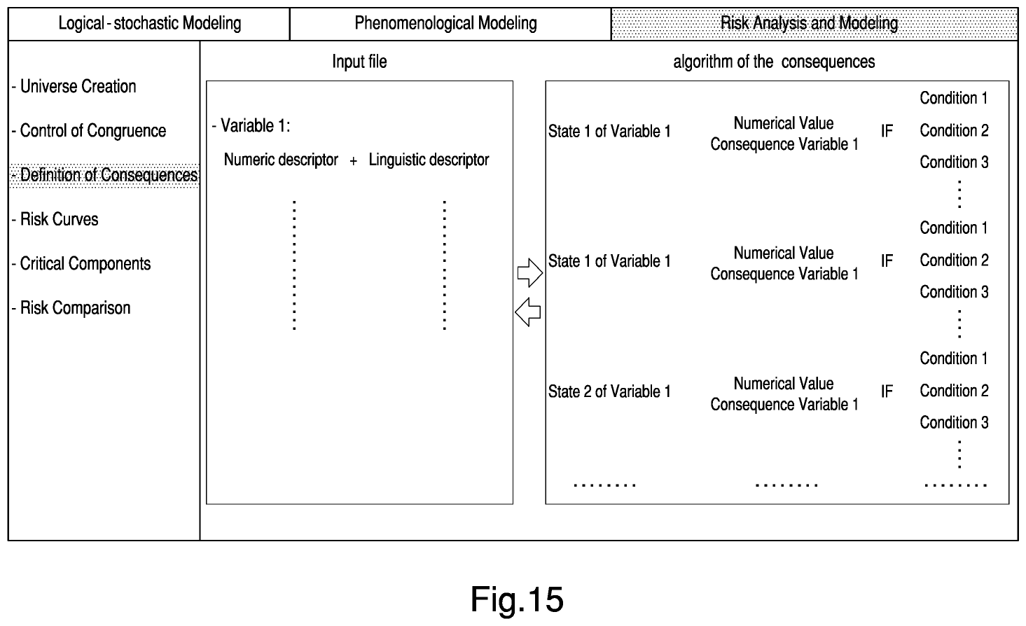

Once the values of the consequences have been assigned, the software procedure 43 calculates, for each single variable of each constituent/scenario, for each of the risk classes (i.e. the “Bin”) and for the entire partition/universe, the distribution of probability, damage and risk associated with the entire analyzed system/phenomenon. FIG. 15 schematically represents a possible structure of the algorithm of the consequences.

With reference to a second possible embodiment, the values of the (numerical and logical) consequences of each single variable are no longer assigned directly by the analyst.

According to such second embodiment, the calculation software procedure 43 for the calculation of the risk comprises a mathematical model for calculating the values of the consequences.

The calculation software procedure 43 for the calculation of the risk is then configured to couple the values of the consequences, multiplying them, to the variable which activated the calculation of the consequence according to its state, thus making it possible to obtain the risk value of each single variable.

The software procedure 43 therefore calculates the risk, the probability and the consequence (i.e. the damage) cumulated for all the variables of the constituent/of the scenario, for each constituent/scenario and for the entire partition/universe.

Also for this second case, the calculation algorithm 4 shall allow the analyst to assign, to each variable of the input file, the value of the consequence (or relative weight with respect to other variables) according to its every possible state and to any restraints imposed by other variables.

In synthesis, the calculation algorithm 4 shall, on one side, allow the analyst to numerically model the phenomenon so as to calculate the values of the consequences according to the state of the scenario variables, and, on the other side, to calculate the value of risk (which will be a function of the calculation algorithm created by the analyst), of the cumulated probability and consequence for each single variable of the constituent/scenario, for each individual constituent/scenario and for the entire partition/universe.

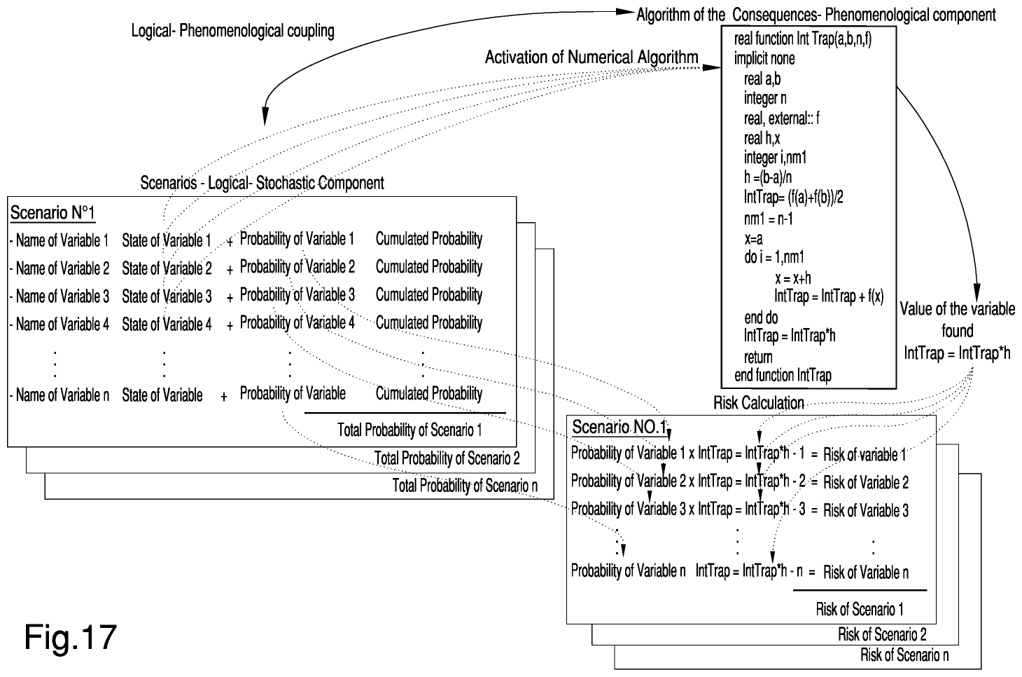

FIG. 17 shows the method of calculating the risk for the entire universe/partition and with reference to the second embodiment.

With reference to a third possible embodiment, the calculation software procedure 43 for the calculation of the risk comprises, in addition to the mathematical model for the calculation of the values of the consequences, also a logical algorithm of connection between the logical-stochastic part, i.e. the constituents/scenarios, and the phenomenological one, i.e. the calculation of the consequences.

The function of the logical connection algorithm is to supply the algorithm of physical calculation of the consequences with the values of the variables and their temporal scans, relating to the phenomenological development of the scenarios, as imposed by the dynamics of the logical structure of each constituent (i.e., its purpose is to define the specific conditions, in which the physical calculation of the risk must be conducted for each possible scenario).

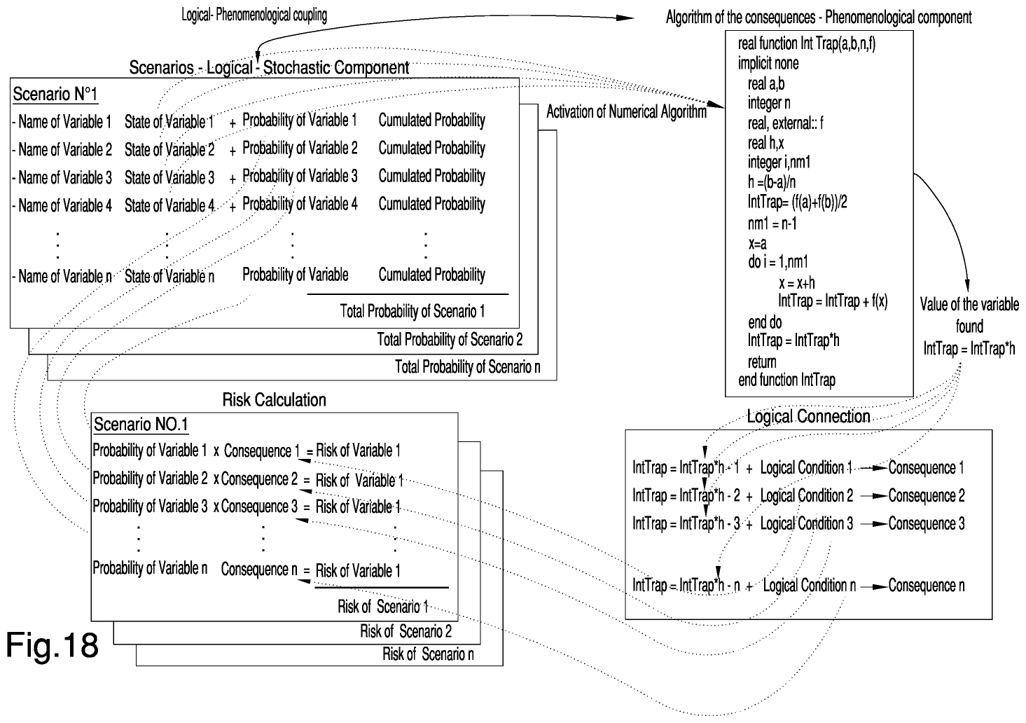

FIG. 18 schematizes the risk calculation procedure for the entire partition/the entire universe with reference to the third embodiment.

Once all the risk values, the consequences and the probabilities (punctual and cumulative) have been obtained, so as to enable the decision-maker to make a decision on how and where to invest its resources, the appliance 1 uses a representation interface 6 for representing the calculated risk profile R.

According to a possible embodiment, the representation interface 6 for representing the calculated risk profile R can comprise a function of calculation and display of a known (and classical) CCDF risk curve (technically the complementary cumulative distribution function), which correlates the value of magnitude of the consequence (in abscissa) with the probability (in ordinate).

Such risk curve is defined by the known correlation:

CCDF=1−CDF

where

CDF=p[a<X<b]=∫ₐ^{b}f(x)dx

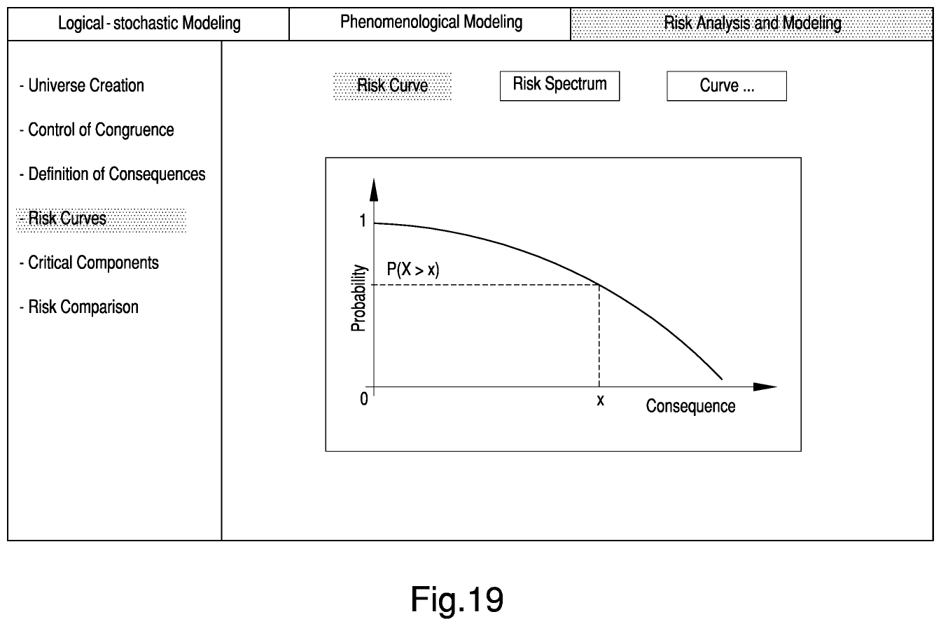

Graphically, the CCDF takes the form represented in FIG. 19.

The calculation algorithm 4 must make it possible to obtain the risk curve through a “condensation process” of the obtained values.

From the decisional point of view, the usefulness of the CCDF risk curve is to provide the decision-maker, for each value of the consequence (magnitude), with the value of probability of exceeding such value (purpose of the CCDF).

Moreover, according to a preferred embodiment, the representation interface 6 for representing the calculated risk profile R comprises one function of calculation and display of an RDF risk spectrum, which allows understanding how the risk is distributed over the entire range of consequences.

Preferably, the RDF risk spectrum (also called Risk Distribution Function—RDF) is constructed by dividing the values of the universe/of the partition of scenarios within 100 homogeneous classes obtained by homogeneously subdividing the entire range of consequences (which varies from time to time according to the decisional problem faced) into 100 parts. The single part (also called “Bin”) is therefore defined by the following correlation:

$$Bin = \frac{{C}_{Max} - {C}_{Min}}{100}$$

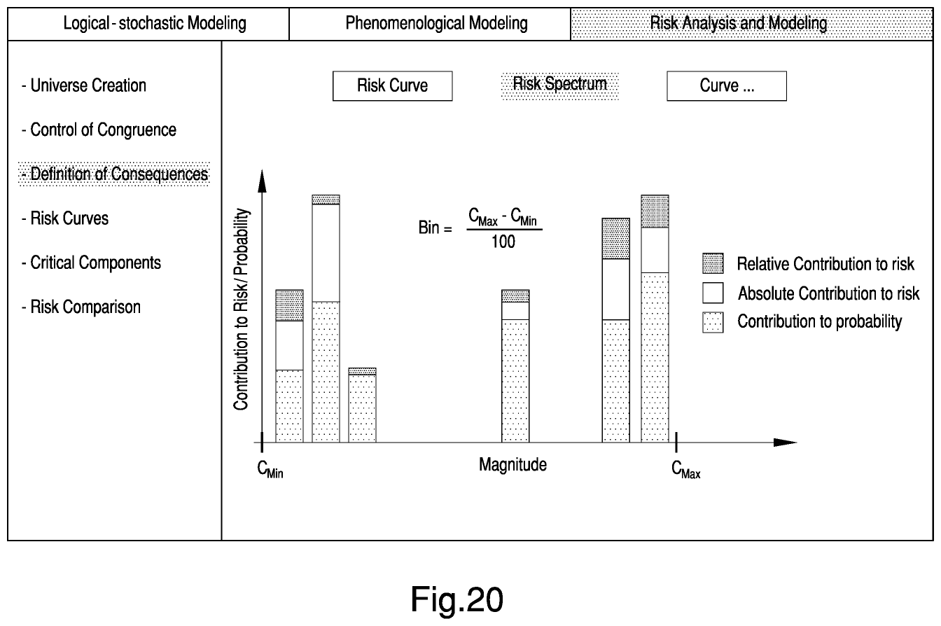

Graphically, the RDF takes the form represented in FIG. 20.

The calculation algorithm 4 must make it possible to obtain the RDF risk spectrum through a “fragmentation process” of the obtained data.

From a decisional point of view, the usefulness of the risk distribution function is to provide the decision-maker with the summary framework of how, within the range of consequences, the risk is distributed or, put differently, how each class of consequence/damage contributes to forming the absolute (and relative) risk and the total probability. Through the RDF risk distribution histogram, the decision-maker is therefore put in a position to choose where to allocate the resources to reduce the risk (low probability and high magnitude events or vice versa?) thus explicitly expressing its own usefulness factor.

Advantageously, the modeling and control interface 5 of the risk allows identifying which are the critical variables (among those identified/selected and contained in the input file I) and their weight in order to model the risk and define a management strategy.

By analyzing the data produced, the calculation algorithm, together with the modeling and control interface 5 of the risk, must provide the decision-maker with the information necessary to define the intervention priority.

In particular, the modeling and control interface 5 for modeling and controlling the risk comprises, for each of the calculated critical variables, one function of calculation and display of at least the following pieces of information: absolute value of the risk, percentage of contribution of the total risk, number of the scenarios in which it is contained, value of the cumulated risk.

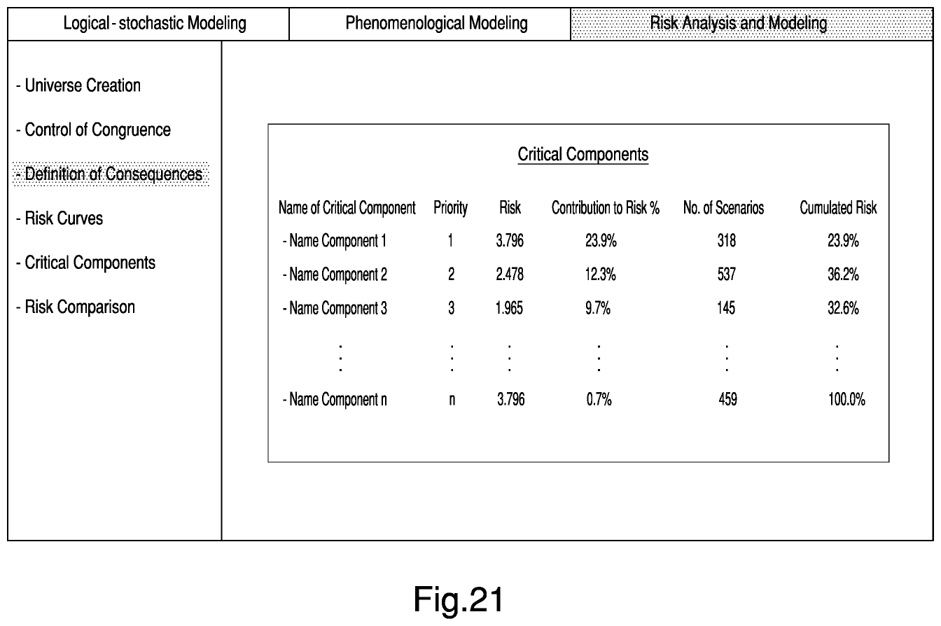

FIG. 21 shows a possible way of representing the results of the analysis of the critical component.

Advantageously, the modeling and control interface 5 is configured to:
identify the critical functions and variables of the complex system/phenomenon analyzed;
select at least one solution to reduce the current risk (profile);
change the input file I according to the selected solution;
calculate the new risk profile by means of the calculation algorithm 4;
compare the new risk profile with the current risk profile to verify the selected solution.

Therefore, the list of critical variables enables the decision-maker both to understand, in a precise way, on which components/variables/functions of the complex system/phenomena analyzed to focus its resources to reduce the risk and, above all, according to which priority; an aspect that neither the CCDF risk curve nor the RDF risk spectrum make it possible to obtain.

The identification of the critical components/variables/functions through the modeling and control interface is therefore the first step in the search for solutions and the relative verification of their effectiveness. Once the critical components/variables/functions have been obtained, in fact, by means of the modeling and control interface it is possible to select the solutions to be adopted to reduce the risk, consistently modify the input file I (to reflect the changes associated with the chosen solutions), conduct the complete simulation to obtain the new risk profile (i.e. that which reflects the configuration of the phenomenon/system downstream of the implemented solutions) and, finally, compare the risk profile of the current situation with that of the new configuration to understand the soundness of the solutions, i.e. whether the solutions actually decrease the risk and how.

Preferably, the modeling and control interface 5 is configured to compare the risk profiles by means of the comparison of the respective CCDF risk curves and of the respective RDF risk spectra.

In addition to comparing risk profiles using the CCDF curve and the RDF spectrum, the interface 5 is configured to also provide details, in terms of risk, probability and damage, for each of the classes represented in the RDF risk spectrum, and the value of the damage, probability and total risk associated with the entire system/phenomenon analyzed. This way, the decision-maker is put in a position to understand whether, and to what extent, the risk and damage, for each of the spectrum classes, i.e. promptly, as well as for the entire system/phenomenon analyzed, i.e. globally, decrease or increase. The detail of the risk and of the damage is of crucial decisional importance because it allows the decision-maker to express, by weighing the details, and justify its own usefulness factor (i.e. the reason for its own decisions).

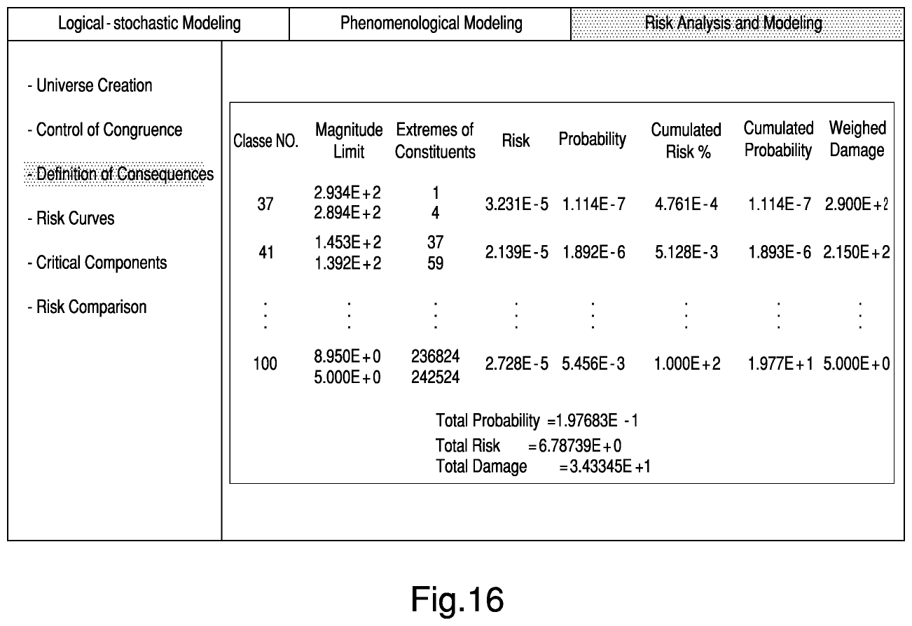

FIG. 16 schematically shows the structure of the details referring to the RDF risk spectrum and containing the value of risk, damage and probability both for each risk class and for the entire system/phenomenon analyzed.

The calculation algorithm 4 must therefore process the data obtained for both the current configuration and those of the new configuration of the phenomenon/system in order to obtain a comparative representation.

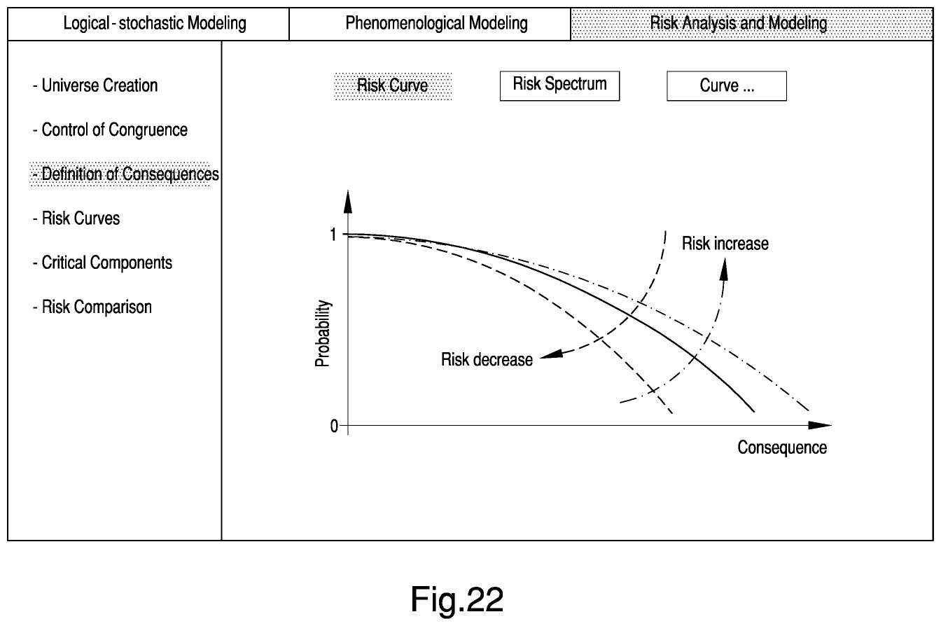

FIGS. 22, 23 and 24 show the usefulness of the CCDF risk curve and the RDF risk spectrum in comparing the risk profile R, respectively.

The CCDF risk curve informs the decision-maker if, and to what extent/where, the risk, in the new configuration, decreases or increases, thus helping to understand whether the identified solutions are effective for the risk management purposes.

The RDF risk spectrum, on the other hand, provides for more detailed information as it informs the decision-maker whether the risk profile changes, and how, or whether it remains the same.

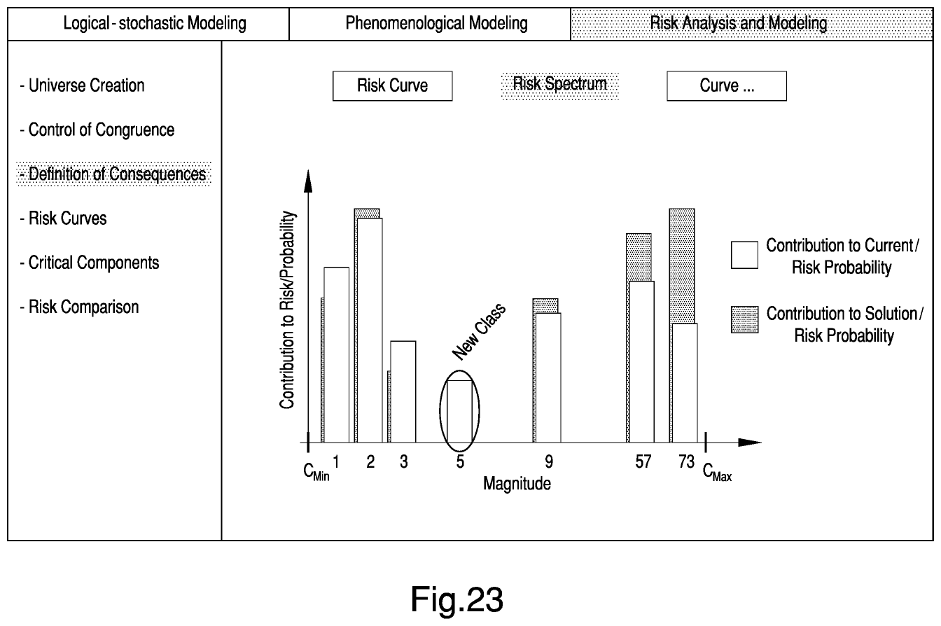

In FIG. 23, for example, it can be seen that the risk increases for the classes 1 and 3, while it decreases for the remaining classes (i.e. 2, 9, 57 and 73) and, moreover, even if globally the risk were to decrease (and this is evident from the numerical details of the risk classes), the introduction of the new solutions would in any case create a new risk class absent in the current configuration, i.e. number 5.

Globally however, the risk profile would remain the same (except for the new class 5).

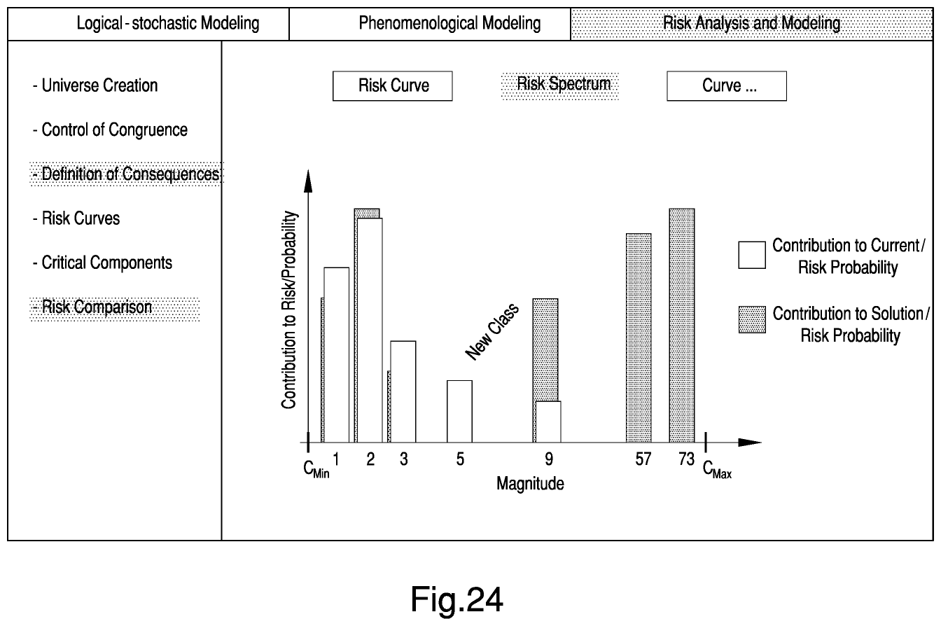

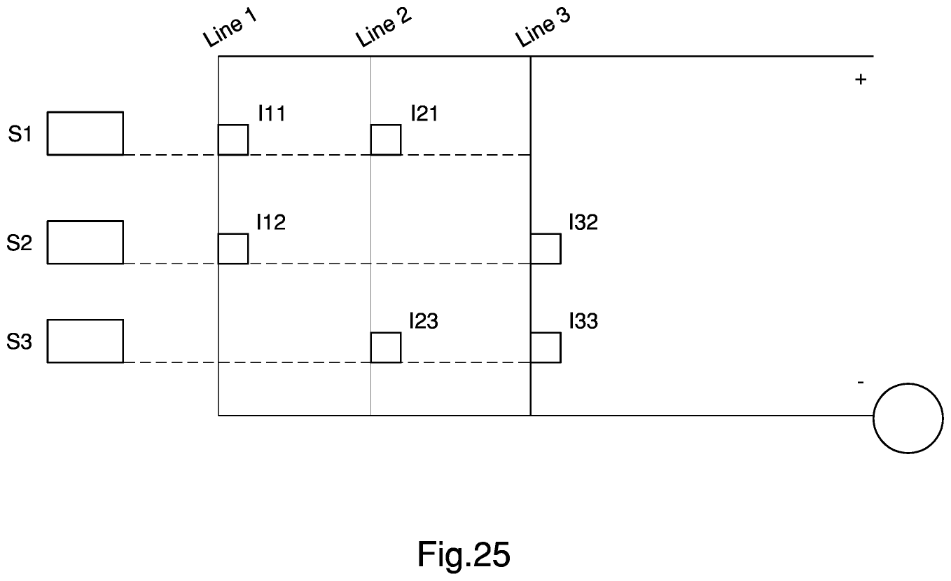

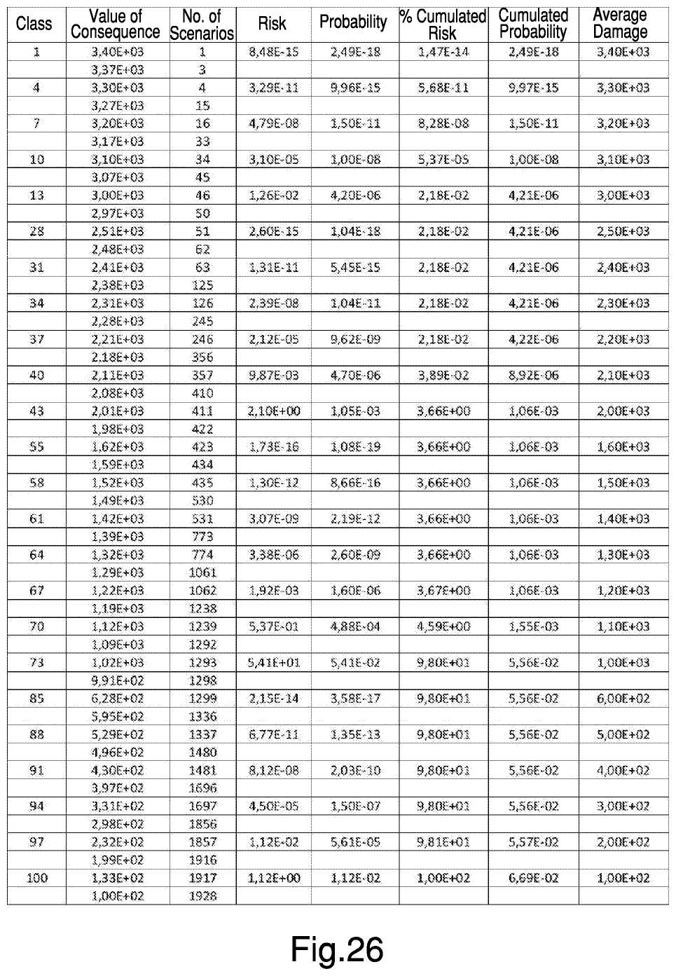

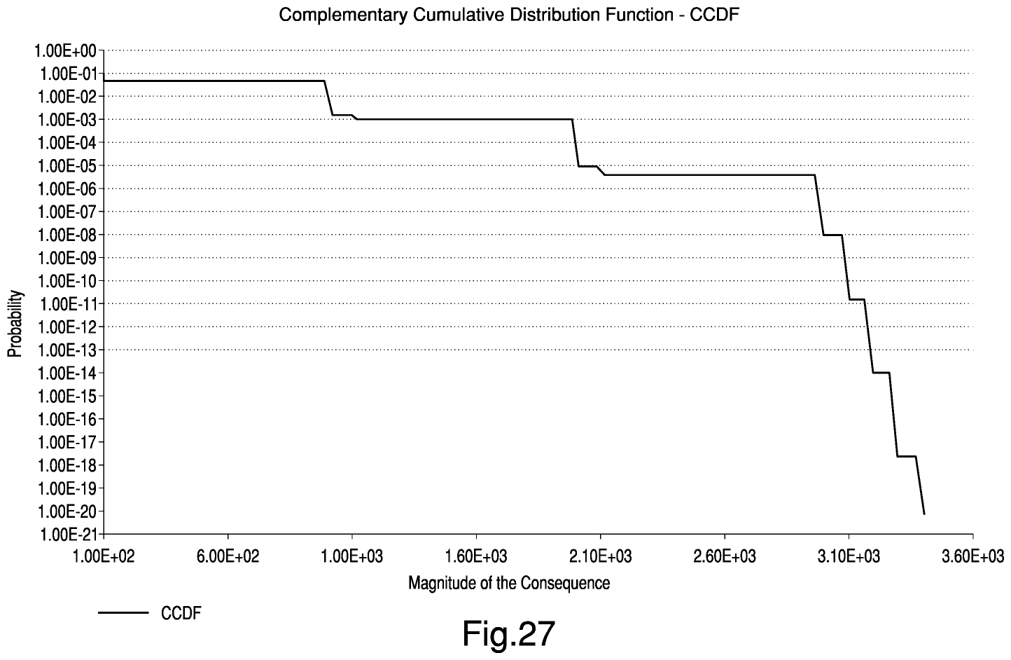

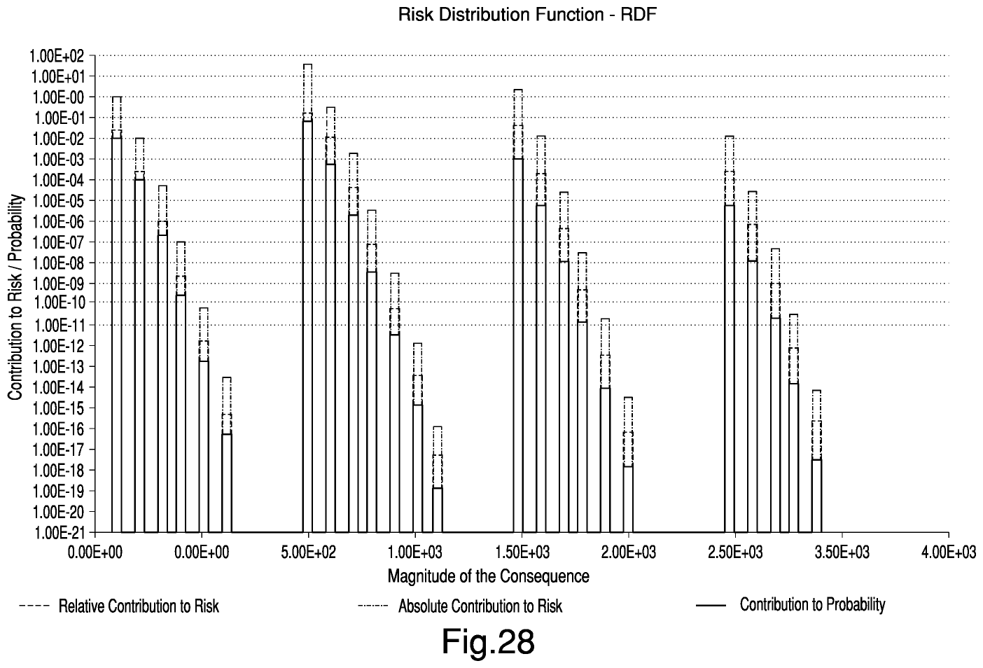

In FIG. 24, on the other hand, it can be seen that the risk profile changes because, in the new configuration, although the new class 5 is always created, on the other hand, the classes with the greatest risk, i.e. 57 and 73, disappear.

In order to further clarify the operation of the appliance according to the invention, a particularly simple practical example is given below.

Numerical Example

Consider an electrical switch which works in two out of three logic, consisting of three sensors, six switches and three lines (FIG. 25).

The six switches I11, I12, I21, I23, I32 and I33 are activated by three sensors S1, S2 and S3.

For current flow, when switching on, the condition must occur in which two switches of at least one of the three lines are closed.

On the other hand, when switching off, i.e., to interrupt current flow, the condition must occur in which at least one switch on all three lines must be open.

The ten variables involved are the three sensors, the six switches and the common cause of failure for which the following failure probability values have been assumed:

### 1. Sensors S1, S2, S3: 9.5E−03

### 2. Switches I11, I12, I21, I23, I32, I33: 1.0E−03

3. Common cause of failure: 5.0E−04

Universe/Partition Generation

Supposing the system to be integral in all its parts (i.e., first start), the total number of scenarios/constituents for the entire spectrum of probability (i.e. that which provides a cumulative probability of exactly 1,0000000 and a residual probability of 0,0000000, therefore without any stochastic cut) and for both phases (i.e. on and off) amounts to 1930.

The maximum number of possible scenarios/constituents is equal to 1024, i.e. 2¹⁰ (i.e. 2, raised to the total number of variables). It is important to notice that the maximum number of possible scenarios/constituents (1024) is lower than the number of calculated scenarios/constituents (1930); this is because, being a multiphase system, some variables are repeated several times in the generation of the partition/universe. In the case of non-multiphase systems, the total number of possible constituents/scenarios cannot be less than those calculated.

As for the entropy of the partition, it assumes the following values:
Maximum entropy of the questions: 1.000000000E+01
Information on possible space: 9.143851322E−01
Maximum Entropy of Universe/Partition: 1.091438513E+01
Information on Probability Distribution: −1.031108377E+01
Effective Partition Entropy: 6.033013573E−01
Fraction of Constituents obtained: 1.884765625E+00
Residual percentage of Max. Entropy: 6.033013573E+00%

Identification of any Inconsistencies

The verification of the soundness of the logical-stochastic modeling, i.e. of the input file used, can be verified by means of the logical selections. In particular, if we want to verify the soundness of the modeling of the two out of three logical problem (i.e. two sensors working out of three), with the following logical selections:
“S1 fault (−)” AND “S2 fault (−)” AND “S3 working (+)”;

### OR

“S1 fault (−)” AND “S2 working (+)” AND “S3 fault (−)”;

### OR

“S1 working (+)” AND “S2 fault (−)” AND “S3 fault (−)”;
   we obtain that, of the 1930 possible scenarios, the number of those which satisfy the selection is equal to 12. This is consistent with the analyzed problem because, with each of the three logical combinations on the status of the three sensors (in two out of three logic) are associated another four on the status of the switches. Therefore, there will be twelve constituents/scenarios (where the sign “+” means “working” and the sign “−” means “fault”):

### 1. S1 (−), S2 (−), S3 (+), I11 (+), I12 (+)

### 2. S1 (−), S2 (−), S3 (+), I11 (−), I12 (+)

### 3. S1 (−), S2 (−), S3 (+), I11 (+), I12 (−)

### 4. S1 (−), S2 (−), S3 (+), I11 (−), I12 (−)

### 5. S1 (−), S2 (+), S3 (−), I21 (+), I23 (+)

### 6. S1 (−), S2 (+), S3 (−), I21 (−), I23 (+)

### 7. S1 (−), S2 (+), S3 (−), I21 (+), I23 (−)

### 8. S1 (−), S2 (+), S3 (−), I21 (−), I23 (−)

### 9. S1 (+), S2 (−), S3 (−), I32 (+), I33 (+)

### 10. S1 (+), S2 (−), S3 (−), I32 (−), I33 (+)

### 11. S1 (+), S2 (−), S3 (−), I32 (+), I33 (−)

### 12. S1 (+), S2 (−), S3 (−), I32 (−), I33 (−)

A further verification of the soundness of the results obtained with the selections can be performed by looking for, within the sub universe/partition consisting of the twelve scenarios/constituents, how many of these end positively, i.e., how many end with the “current flow” event. Obviously the correct answer is “none”, i.e. the selection must give a zero result.

If we make the same selection chosen for the first phase for the second phase of stoppage as well, i.e., to interrupt the current flow, we obtain that, out of the 1930 possible constituents/scenarios, the number of those that satisfy the selection is equal to 360. If we then try to find out whether, out of the 360 constituents/scenarios, there are any which, despite the malfunctioning of two sensors out of three, allow the system to work properly, i.e., to continue to interrupt the current, we discover that, out of the 360 constituents/scenarios, as many as 117 allow the system to continue to work. This thanks to switch failures which occurred in the first phase, i.e. switches that fail while remaining open (or closed depending on the convention) thus preventing the flow of current when they should have been closed (or opened depending on the convention).

In addition to this, we also discover that, not only are there constituents which, in second phase, end up with the interruption of the current due to the faults which occurred in the first phase, but, thanks to these, the overall probability of success, despite the malfunctioning of the two out of three logic of the sensors, is greater than that of being unsuccessful. Numerically, the probability of success (given by the algebraic sum of the 117 constituents/scenarios), amounts to 5.248936690310595E−04, while that of being unsuccessful (given by the algebraic sum of the 243 constituents/scenarios) amounts to 2.604821256169883E−04.

If, instead, a selection is made which eliminates all the faults to the switches of the first phase, i.e., if the selection is made on the entire partition/on the entire universe with the aim of identifying the sub universe/partition in which the switches are present in the sole working state with the following logical selection:
I11 (+), I12 (+), I21 (+), I23 (+), I32 (+), I33 (+)
   we obtain that, out of the 1930 possible constituents/scenarios, the number of those that satisfy the selection is equal to 125. If to this sub universe/partition we apply the selection to verify the correct modeling of the two out of three logic of the sensors, we obtain, in a completely specular way to the first phase, that, out of the 1930 possible constituents/scenarios, the number of those which satisfy the selection is 12. If then, as carried out for the first phase, we want to verify the soundness of the results obtained with the selections within the sub universe/partition consisting of the 12 constituents/scenarios, we can try and find out how many of them end positively, i.e., how many end with the “current stop” event. Obviously the correct answer is “none”, i.e., the selection must provide, in a completely specular way to phase one for the current flow, a zero result.

It can be seen that, if there were no faults in the first phase, the system of sensors behaves in the second phase as a strict two out of three (as already verified for the first phase, which starts from integral conditions).

It is important to notice how, once the partition/universe has been generated, all congruency checks can be performed without the theoretical need to read any scenario/constituent.

Stochastic Cut

To understand the effects and importance of the stochastic cut on the generation of the universe/partition (and, consequently, on the risk analysis), choosing the probability spectrum from 1E−08 to 0.0000000, instead of the 1930 constituents/scenarios, obtained by analyzing the entire probability spectrum (i.e. that from 1.0000000 to 0.0000000), we obtain 205 of them, plus obviously a residual one, for a cumulative probability value equal to 9.99998228E−01 and a residual probability value equal to 1.772038E−06. The constituents/scenarios have been reduced from 1930 to 205, plus obviously a residual probability, of everything which is no longer taken into account, less than 2 in 10⁶ (i.e., 2 in one million).

As for the entropy of the partition, it assumes the following values:
Maximum entropy of the Questions: 1.000000000E+01 (ten)
Information on Possible Space: −2.313499473E+00
Maximum Entropy of Universe/Partition: 7.686500527E+00
Information on Probability Distribution: −7.083213283E+00
Effective Partition Entropy: 6.032872441E−01
Fraction of Constituents obtained: 2.011718750E−01
Residual percentage of Max. Entropy: 6.032872441E+00%

If we now apply, to the newly generated sub universe/partition, the selections applied above for the congruence control of the two out of three logic modeling, we obtain, for the first phase (the switch-on phase), that the selected constituents are 9 instead of 12, found for the complete partition/universe. In fact, if we list the probabilities of each of the 12 constituents, namely:

$$\begin{matrix}1 \; 8.916932217805 E \text{-} 05 & 7 \; 8.925858075881 E \text{-} 08 \\ 2 \; 8.925858075881 E \text{-} 08 & 8 \; 8.934792868750 E \text{-} 11 \\ 3 \; 8.925858075881 E \text{-} 08 & 9 \; 8.916932217805 E \text{-} 05 \\ 4 \; 8.934792868750 E \text{-} 11 & 10 \; 8.925858075881 E \text{-} 08 \\ 5 \; 8.916932217805 E \text{-} 05 & 11 \; 8.925858075881 E \text{-} 08 \\ 6 \; 8.925858075881 E \text{-} 08 & 12 \; 8.934792868750 E \text{-} 11\end{matrix}$$

it can be noticed that only three constituents/scenarios, i.e. the number 4, 8 and 12 (those highlighted bold), have a lower probability than the cut threshold.

As far as the cumulated probabilities are concerned, we obtain that, for the 12 constituents/scenarios of the complete case, it is equal to 2.680437860625000E−04 while, for the 9 scenarios of the reduced universe (to which the stochastic cut 1E−08 has been applied), it is equal to 2.680435180187140E−04, with a difference between the two equal to 2.68044E−10, therefore completely negligible.

For the second phase (that of switch-off), always applying the selections on the entire universe without excluding the failures of the first phase, we obtain 57 constituents/scenarios, instead of the 360 previously obtained with the analysis of the complete universe, of which 30, instead of the 117 previously obtained with the analysis of the complete universe, produce a positive result, i.e., they permit interrupting the current flow despite the malfunction of the two out of three logic. Numerically, the probability of success (given by the algebraic sum of the 30 constituents/scenarios), is equal to 5.248902863966749E−04, compared to that of 5.248936690310595E−04 of the previous 117 constituents/scenarios obtained from the analysis of the complete partition/universe, while that of being unsuccessful (given by the algebraic sum of the 27 constituents/scenarios) is equal to 2.604761425877679E−04, compared to that of 2.604821256169883E−04 of the previous 243 constituents/scenarios obtained from the analysis of the complete universe/partition. The probabilities lost due to the stochastic cut will be equal to 3.382634384426630E−09, for the 87 scenarios/constituents of the first phase (given by the difference between 117 and 30), and 5.983029219667374E−09, for the 216 of the second phase (given by the difference between 243 and 27), therefore completely negligible.

Comparing therefore the probabilities of success of the system in absence or presence of stochastic cut, we obtain the values of 9.988543322090491E−01 in absence of cut (complete universe) and 9.988531519714849E−01 in presence of cut (reduced universe), the difference of which is equal to 1.1802375641245530E−06, therefore completely negligible.

The above example shows how the stochastic cut allows obtaining results which, from the decisional point of view, are substantially unchanged, but with a cost, in terms of calculation time, significantly lower because, instead of the 1930 constituents/scenarios of the entire universe, it requires the analysis of only 205 constituents/scenarios. In practice, this means that the same decisions can be taken by analyzing only 10.6% of the scenarios.

Risk Calculation and Representation

The example considered is well suited to explain the calculation of the consequences according to the first path, i.e., that which provides for the direct assignment of consequence values (therefore without the need for an algorithm for phenomenological calculation).

By assigning to the sensors a failure cost of €1,000 and to the switches a failure cost of €100, we obtain that the number of constituents contributing to the risk is 1928, i.e. 2 less than the total (i.e., that generated by the common cause and the all positive one), and a contribution to the total probability of 6.68997309E−02. The constituent/scenario which generates the maximum consequence is the 832th with a generated consequence of €3,400. The constituent/scenario which generates the greatest risk is the 1689th with a generated risk of 9,06667877E+00. Finally, the constituent/scenario with minimum probability is the 988th with a probability of 9.01655749E−21. In addition, the values of risk, probability, % of cumulative risk and cumulative probability for each single class are shown on the table in FIG. 26.

The value of total cumulative probability, total risk and total expected damage (fundamental for insurance purposes) is equal to:
Total probability=6,6899700E−02
Total Risk=5.7879000E+01
Expected Damage=8.6516000E+02

The risk curve therefore takes the shape shown in FIG. 27.

The risk spectrum, on the other hand, takes the shape shown in FIG. 28.

It is important to notice that both the curve and the risk spectrum/histogram are not affected by the stochastic cut in any way (therefore the graphs in FIGS. 27 and 28 remain identical). This confirms the fact that, in this specific case, the stochastic cut, is, from the decisional point of view, irrelevant.

It has in practice been ascertained that the described invention achieves the intended objects.

In particular, the fact is underlined that the appliance according to the invention allows characterizing, from a functional point of view, the analyzed system/phenomenon in order to identify both the variables involved and their logical-stochastic correlations. The appliance according to the invention allows generating in an automated way a complete universe or a partition otherwise not generatable by hand, neither by an analyst nor by a group of analysts, because of both the considerable complexity of identification of all possible combinations (cognitive barrier) and because of the time that such a manual procedure would require (time barrier).

The appliance according to the invention allows (thanks to the selections tool) managing and manipulating the constituents/scenarios produced at different levels of abstraction, from different angles and for different purposes, all necessary for both the analyst and the decision-maker to better understand the analyzed system/phenomenon, to conduct the necessary control of congruence (with empirical evidence), and to support the decision only for the part of risk under consideration.

The analyst and the decision-maker can, therefore, select a part of the created universe/partition, according to criteria which are functional to the decision to be taken, and analyze it as a new decision-making universe without this compromising the soundness and completeness of the analysis.

The appliance according to the invention allows coupling the consequences, both positive and negative, which each variable, selected and used for the generation of the partition/universe (of constituents/scenarios), carries with it in order to calculate the risk of the entire partition/of the entire universe (and not only of some scenarios selected in a heuristic/experiential way).

The appliance according to the invention allows building the CCDF cumulative complementary curve and the RDF risk spectrum both necessary to verify, in a comparative sense, the soundness of the hypothesized solutions to reduce the risk and allow the decision-maker to express its own factor of usefulness.

The appliance according to the invention makes it possible to calculate the risk, the probability and the damage both for each of the classes represented in the RDF risk spectrum, i.e., promptly, and for the entire system/phenomenon analyzed, i.e., globally.

The appliance according to the invention permits identifying and prioritizing the critical variables (functions) (among those identified/selected and present in input I) according to their contribution to the risk of the entire system/phenomenon.

1. An appliance for risk analysis and modeling of complex systems and phenomena, comprising:
a processing unit operatively connected to a characterization interface, comprising a calculation algorithm and configured to receive an input file at input comprising a plurality of variables/functions of interest and of interdependencies between said variables/functions, necessary to respond to a specific decision-making problem, and to identify by means of this calculation algorithm a risk profile of said complex system/phenomenon; and
a modeling and control interface for modeling and controlling the risk, configured to identify critical variables and their weight in order to model the risk profile and define a management strategy.

2. The appliance according to claim 1, comprising a characterization interface of a complex system/phenomenon to be analyzed, configured to generate said input file.

3. The appliance according to claim 2, wherein said characterization interface comprises:
an interface for functional analysis;
an interface for command, control and communication analysis;
an interface for job analysis;
an interface for decision-making points analysis; and
an interface for phenomenological analysis.

4. The appliance according to claim 3, wherein said interface for functional analysis is configured to simultaneously represent:
a list of variables and functions that make up the complex system/phenomenon to be analyzed; and
sequentiality, length of time and mutual interdependencies between said variables and functions.

5. The appliance according to claim 3, wherein said interface for functional analysis is configured to select out of said represented variables and functions only the variables and functions which describe a decision-making problem to which one wants to reply.

6. The appliance according to claim 3, wherein said interface for functional analysis is configured to store inside said input file said variables and functions selected with the respective dependencies.

7. The appliance according to claim 1, wherein said input file comprises data represented in a numeric-linguistic type form.

8. The appliance according to claim 3, wherein said interface for command, control and communication analysis is configured to represent inter-functional relations between human functions involved in said complex system/phenomenon to be analyzed, comprising:
a diagram of the command chain, indicating who commands whom/what among said human functions;
a diagram of the control chain, indicating who controls whom/what among said human functions; and
a diagram of the communication chain, indicating who communicates with whom/what and in what way among said human functions.

9. The appliance according to claim 3, wherein said interface for command, control and communication analysis is configured to identify which types of people and how many people cover every function of said complex system/phenomenon to be analyzed.

10. The appliance according to claim 8, wherein said interface for command, control and communication analysis is configured to represent said diagram of the command chain, said diagram of the control chain and said diagram of the communication chain for each of a plurality of phases of said complex system/phenomenon to be analyzed, in the event of said complex system/phenomenon developing in several phases.

11. The appliance according to claim 3, wherein said interface for job analysis is configured to define the activities of people in the complex system/phenomenon to be analyzed.

12. The appliance according to claim 3, wherein said interface for decision-making points analysis is configured to highlight the decision-making points in which each person could review their own decisions.

13. The appliance according to claim 3, wherein at least one of said interface for command, control and communication analysis, said interface for job analysis and said interface for decision-making points analysis is configured to store inside said input file said variables and functions selected with the respective dependencies.

14. The appliance according to claim 3, wherein said interface for phenomenological analysis is configured to generate a mathematical model of calculation of characteristic times of said complex system/phenomenon and of the patterns of the variables of interest to be used as reference in the construction of said input file.

15. The appliance according to claim 1, wherein each variable stored inside said input file comprises a linguistic descriptor and a numeric descriptor.

16. The appliance according to claim 1, wherein said calculation algorithm comprises a logic-stochastic simulator.

17. The appliance according to claim 1, wherein said calculation algorithm implemented on said processing unit comprises:
a generation software procedure for the generation of a complete universe/partition of the possible scenarios of said complex system/phenomenon, starting from said input file;
an identification software procedure for the identification of any logic-stochastic inconsistencies; and
a calculation software procedure for the calculation of said risk profile of the complex system/phenomenon.

18. The appliance according to claim 1, comprising at least one representation interface for representing said calculated risk profile.

19. The appliance according to claim 17, wherein said generation software procedure comprises at least one function for the calculation of the total cumulative probability of all the produced scenarios and the residual probability of the produced scenarios, and by the fact that said generation software procedure comprises a function for the verification of the following conditions:
p_{Universe}=Σᵢp_{Scenario}_{ᵢ}=1.0000000
p_{Residual}=Σ_{j,j≠from all others “i”}p_{Scenario}_{ⱼ}=0.0000000,

20. The appliance according to claim 19, wherein said generation software procedure comprises a function for the calculation of the entropy of the partition, defined as:
$$S = {\sum }_{i = 1}^{M} [ {p}_{n} \times {log}_{2} ( \frac{1}{{p}_{n}} ) ]$$
where:
pₙ=probability of the n-th constituent/scenario; and
M=total number of constituents/scenarios.

21. The appliance according to claim 17, wherein said identification software procedure for the identification of any inconsistencies is configured to perform a sampling of said scenarios based on the length of each scenario with respect to the average of the scenarios present in the universe/partition.

22. The appliance according to claim 1, wherein said calculation algorithm implemented on said processing unit comprises:
a selection and extraction software procedure for the selection and extraction of the constituents/scenarios from the complete universe/partition generated; and
a creation software procedure for the creation of the events from the sum of the constituents/scenarios extracted from the complete universe/partition.

23. The appliance according to claim 17, wherein said calculation software procedure for the calculation of the risk profile is configured to:
assign to each variable of the input file a value of the consequence according to every possible state of the variable and to any restraints imposed by other variables; and
once having assigned the values of the consequences to each variable of the input file, calculate the value of risk and the accumulated values of probability and consequence for each single variable of scenario, of each scenario and for the entire partition/universe.

24. The appliance according to claim 23, wherein said calculation software procedure for the calculation of the risk profile comprises a mathematical model for the calculation of said value of the consequence.

25. The appliance according to claim 24, wherein said calculation software procedure for the calculation of the risk comprises a logic algorithm of connection between said scenarios and the model for the calculation of said values of the consequences.

26. The appliance according to claim 1, wherein said representation interface for representing said calculated risk profile comprises at least one function of calculation and display of a risk curve which correlates the value of magnitude of the consequence with the probability.

27. The appliance according to claim 1, wherein said representation interface for representing said calculated risk profile comprises at least one function of calculation and display of a risk spectrum.

28. The appliance according to claim 1, wherein said modeling and control interface for modeling and controlling the risk comprises at least one function of calculation and display of at least one of the following pieces of information: absolute and relative value of the risk, percentage of contribution of the total risk, value of the total and relative damage, value of the total and relative probability, number and identification of the scenarios.

29. The appliance according to claim 1, wherein said modeling and control interface is configured to:
identify the critical variables/functions of the complex system/phenomenon analyzed;
select at least one solution to reduce the current risk profile;
change the input file according to the at least one selected solution;
calculate the new risk profile by means of said calculation algorithm; and
compare the new risk profile with the current risk profile to verify the selected solution.

30. The appliance according to claim 29, wherein said step to compare is taken by means of the comparison of the respective risk curves and of the respective risk spectra of the new risk profile and of the current risk profile.
